(19) United States
(12) Patent Application Publication
(10) Pub. No.: US 2024/0107579 A1
(43) Pub. Date: Mar. 28, 2024

(54) IDLE PERIOD HANDLING FOR MULTIPLE TRANSMIT RECEIVE POINT OPERATION

(71) Applicant: QUALCOMM Incorporated, San Diego, CA (US)

(72) Inventors: Luanxia YANG, Beijing (CN); Changlong XU, Beijing (CN); Jing SUN, San Diego, CA (US); Xiaoxia ZHANG, San Diego, CA (US); Shaozhen GUO, Beijing (CN); Rajat PRAKASH, San Diego, CA (US); Hao XU, Beijing (CN); Siyi CHEN, Beijing (CN)

(21) Appl. No.: 18/264,131

(22) PCT Filed: Apr. 23, 2021
(86) PCT No.: PCT/CN2021/089323

§ 371 Date: Aug. 3, 2023

(51) Int. Cl. H04W 74/08

(52) U.S. Cl. CPC H04W 74/0808

(57) ABSTRACT

Various aspects of the present disclosure generally relate to wireless communication. In some aspects, a user equipment (UE) may communicate with multiple transmit receive points (TRPs) in a frame based equipment mode. A wireless node (e.g., the UE and/or one or more of the multiple TRPs) may determine, among the UE and the multiple TRPs, an initiating node that acquired a current channel occupancy time. The wireless node may determine a transmission pattern that includes one or more idle periods based at least in part on a fixed frame period structure associated with the initiating node that acquired the current channel occupancy time. The wireless node may refrain from transmitting during the one or more idle periods, wherein the one or more idle periods include at least an idle period associated with the wireless node. Numerous other aspects are described.

### FIELD OF THE DISCLOSURE

Aspects of the present disclosure generally relate to wireless communication and to techniques and apparatuses associated with idle period handling for multiple transmit receive point (mTRP) operation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes determining, among the UE and multiple transmit receive points (TRPs) communicating with the UE in a frame based equipment (FBE) mode, an initiating node that acquired a current channel occupancy time; determining a transmission pattern that includes one or more idle periods based at least in part on a fixed frame period (FFP) structure associated with the initiating node that acquired the current channel occupancy time; and refraining from transmitting during the one or more idle periods, wherein the one or more idle periods include at least an idle period associated with the UE.

In some aspects, a method of wireless communication performed by a TRP includes determining, among a UE, the TRP, and one or more other TRPs communicating with the UE in an FBE mode, an initiating node that acquired a current channel occupancy time; determining a transmission pattern that includes one or more idle periods based at least in part on an FFP structure associated with the initiating node that acquired the current channel occupancy time; and refraining from transmitting during the one or more idle periods, wherein the one or more idle periods include at least an idle period associated with the TRP.

In some aspects, a UE for wireless communication includes a memory and one or more processors, coupled to the memory, configured to: determine, among the UE and multiple TRPs communicating with the UE in an FBE mode, an initiating node that acquired a current channel occupancy time; determine a transmission pattern that includes one or more idle periods based at least in part on an FFP structure associated with the initiating node that acquired the current channel occupancy time; and refrain from transmitting during the one or more idle periods, wherein the one or more idle periods include at least an idle period associated with the UE.

In some aspects, a TRP for wireless communication includes a memory and one or more processors, coupled to the memory, configured to: determine, among a UE, the TRP, and one or more other TRPs communicating with the UE in an FBE mode, an initiating node that acquired a current channel occupancy time; determine a transmission pattern that includes one or more idle periods based at least in part on an FFP structure associated with the initiating node that acquired the current channel occupancy time; and refrain from transmitting during the one or more idle periods, wherein the one or more idle periods include at least an idle period associated with the TRP.

In some aspects, a non-transitory computer-readable medium storing a set of instructions for wireless communication includes one or more instructions that, when executed by one or more processors of a UE, cause the UE to: determine, among the UE and multiple TRPs communicating with the UE in an FBE mode, an initiating node that acquired a current channel occupancy time; determine a transmission pattern that includes one or more idle periods based at least in part on an FFP structure associated with the initiating node that acquired the current channel occupancy time; and refrain from transmitting during the one or more idle periods, wherein the one or more idle periods include at least an idle period associated with the UE.

In some aspects, a non-transitory computer-readable medium storing a set of instructions for wireless communication includes one or more instructions that, when executed by one or more processors of a TRP, cause the TRP to: determine, among a UE, the TRP, and one or more other TRPs communicating with the UE in an FBE mode, an initiating node that acquired a current channel occupancy time; determine a transmission pattern that includes one or more idle periods based at least in part on an FFP structure associated with the initiating node that acquired the current channel occupancy time; and refrain from transmitting during the one or more idle periods, wherein the one or more idle periods include at least an idle period associated with the TRP.

In some aspects, an apparatus for wireless communication includes means for determining, among the apparatus and multiple TRPs communicating with the apparatus in an FBE mode, an initiating node that acquired a current channel occupancy time; means for determining a transmission pattern that includes one or more idle periods based at least in part on an FFP structure associated with the initiating node that acquired the current channel occupancy time; and means for refraining from transmitting during the one or more idle periods, wherein the one or more idle periods include at least an idle period associated with the apparatus.

In some aspects, an apparatus for wireless communication includes means for determining, among a UE, the apparatus, and one or more TRPs communicating with the UE in an FBE mode, an initiating node that acquired a current channel occupancy time; means for determining a transmission pattern that includes one or more idle periods based at least in part on an FFP structure associated with the initiating node that acquired the current channel occupancy time; and means for refraining from transmitting during the one or more idle periods, wherein the one or more idle periods include at least an idle period associated with the apparatus.

Aspects generally include a method, apparatus, system, computer program product, non-transitory computer-readable medium, user equipment, base station, transmit receive point, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, RF chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIG. 3 illustrates an example logical architecture of a distributed radio access network, in accordance with the present disclosure.

FIG. 4 is a diagram illustrating an example of multiple transmit receive point (mTRP) communication, in accordance with the present disclosure.

FIGS. 5A-5B are diagrams illustrating an example of a fixed frame period (FFP) that includes a channel occupancy time during which one or more devices may conduct transmissions in an unlicensed channel, in accordance with the present disclosure.

FIG. 6 is a diagram illustrating an example associated with idle period handling for mTRP operation where multiple TRPs share a common FFP structure, in accordance with the present disclosure.

FIGS. 7A-7C are diagrams illustrating examples associated with TRP behavior related to idle period handling for mTRP operation where multiple TRPs have different FFP structures, in accordance with the present disclosure.

FIGS. 8A-8C are diagrams illustrating examples associated with UE behavior related to idle period handling for mTRP operation where multiple TRPs have different FFP structures, in accordance with the present disclosure.

FIGS. 9A-9B are diagrams illustrating examples associated with TRP behavior related to idle period handling for mTRP operation where an idle period of another TRP overlaps with the start of an FFP, in accordance with the present disclosure.

FIGS. 10-11 are diagrams illustrating example processes associated with idle period handling for mTRP operation, in accordance with the present disclosure.

FIGS. 12-13 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

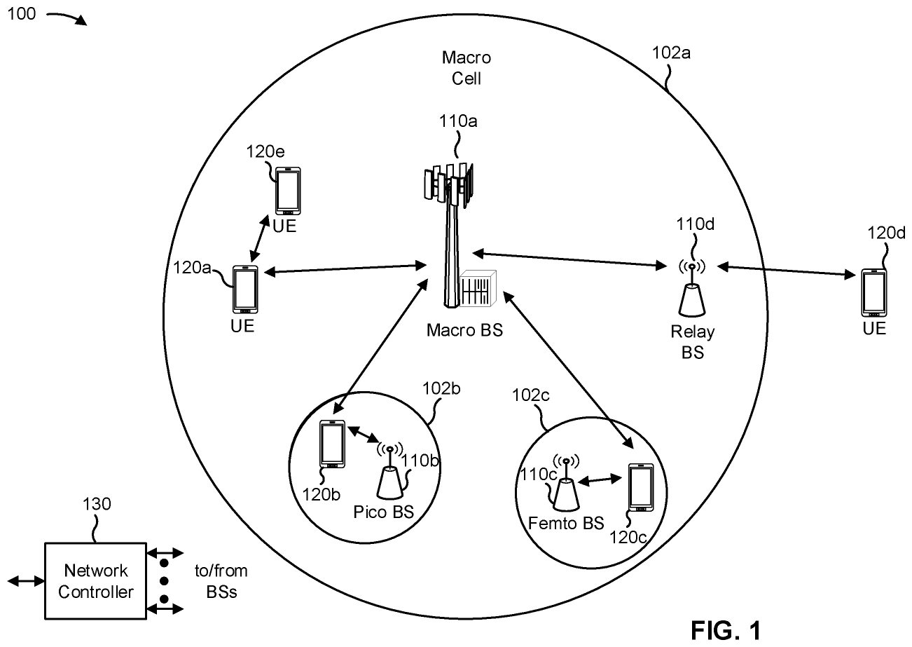

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

In some aspects, devices of wireless network 100 may communicate with one another using a licensed radio frequency spectrum band and/or an unlicensed radio frequency spectrum band. For example, a base station 110 and a UE 120 may communicate using a RAT such as Licensed-Assisted Access (LAA), Enhanced LAA (eLAA), Further Enhanced LAA (feLAA), and/or NR-Unlicensed (NR-U), among other examples. In some aspects, one or more wireless local area network (WLAN) access points and one or more WLAN stations (not shown in FIG. 1) may communicate with one another using only the unlicensed radio frequency spectrum band (and not the licensed radio frequency spectrum band). The unlicensed radio frequency spectrum band may therefore be shared by the base stations 110, the UEs 120, the WLAN access point(s), the WLAN station(s), and/or other devices. Because the unlicensed radio frequency spectrum band may be shared by devices operating under different protocols (e.g., different RATs), transmitting devices may need to contend for access to the unlicensed radio frequency spectrum band prior to transmitting over the unlicensed radio frequency spectrum band.

For example, in a shared or unlicensed frequency band, a transmitting device may contend against other devices for channel access before transmitting on a shared or unlicensed channel to reduce and/or prevent collisions on the shared or unlicensed channel. To contend for channel access, the transmitting device may perform a channel access procedure, such as a listen-before-talk (or listen-before-transmit) (LBT) procedure or another type of channel access procedure, for shared or unlicensed frequency band channel access. The channel access procedure may be performed to determine whether the physical channel (e.g., the radio resources of the channel) are free to use or are busy (e.g., in use by another wireless communication device such as another UE, an IoT device, and/or a WLAN device, among other examples). The channel access procedure may include sensing or measuring the physical channel (e.g., performing a reference signal received power (RSRP) measurement, detecting an energy level, or performing another type of measurement) during a channel access gap (which may also be referred to as a contention window) and determining whether the shared or unlicensed channel is free or busy based at least in part on the signals sensed or measured on the physical channel (e.g., based at least in part on whether the measurement satisfies a threshold, such as an energy detection threshold (EDT)). If the transmitting device determines that the channel access procedure was successful, the transmitting device may perform one or more transmissions on the shared or unlicensed channel during a transmission opportunity (TXOP), which may extend for a channel occupancy time (COT).

As indicated above, FIG. 1 is provided as an example. Other examples may differ from what is described with regard to FIG. 1.

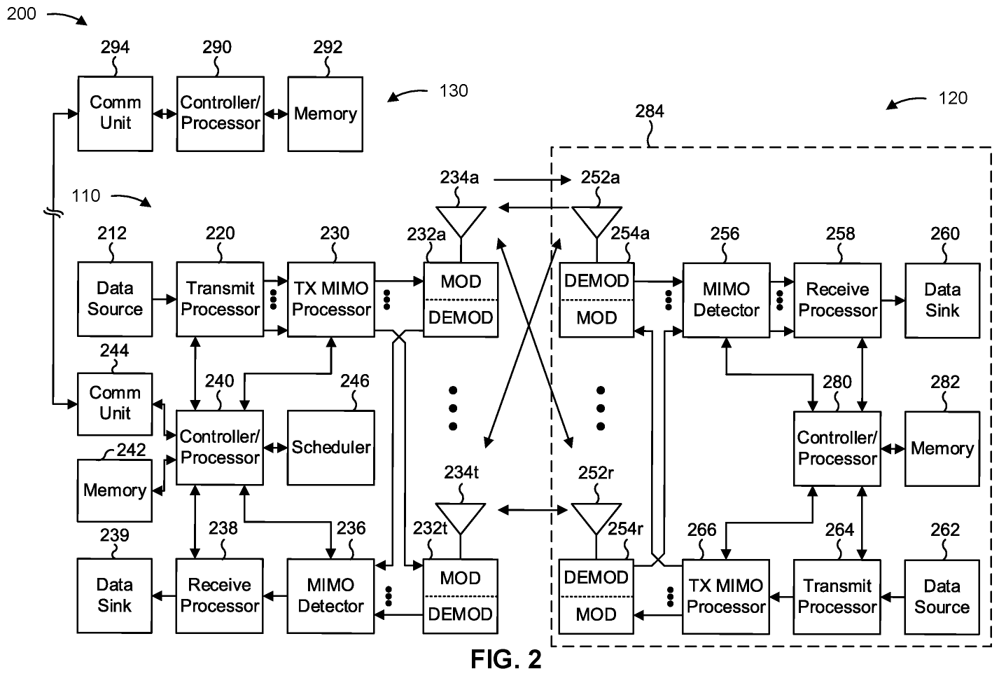

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

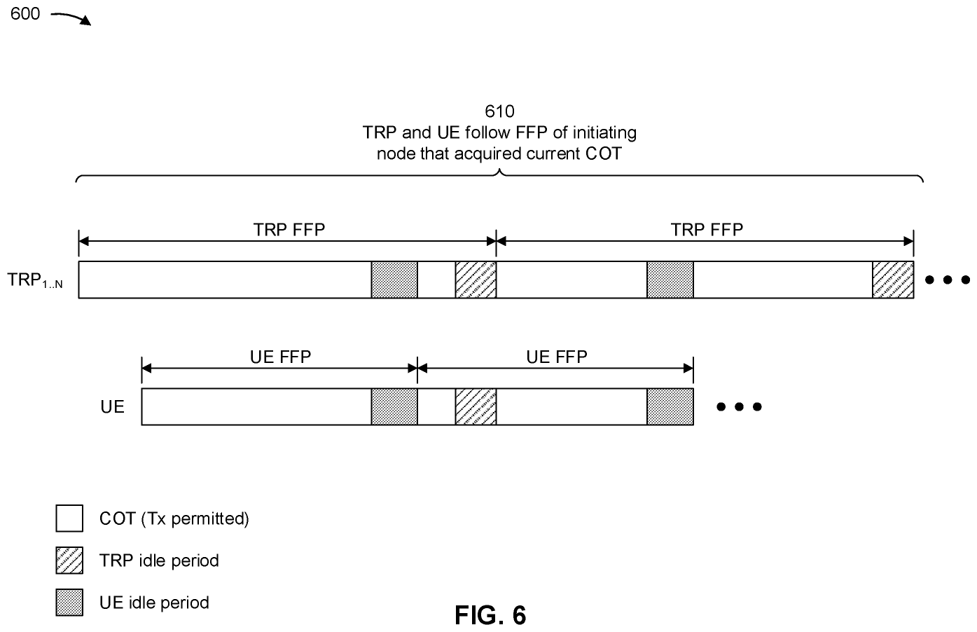

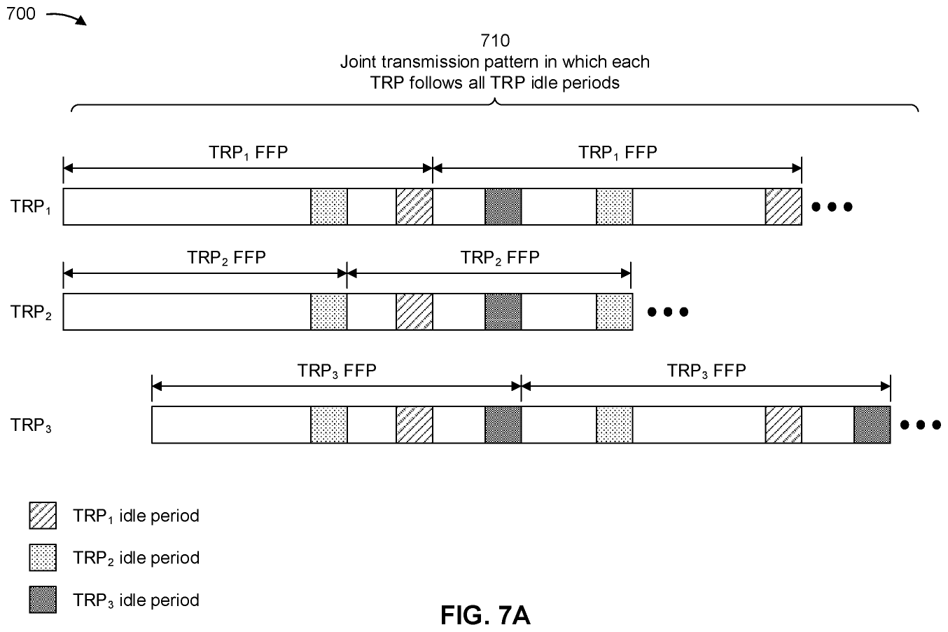

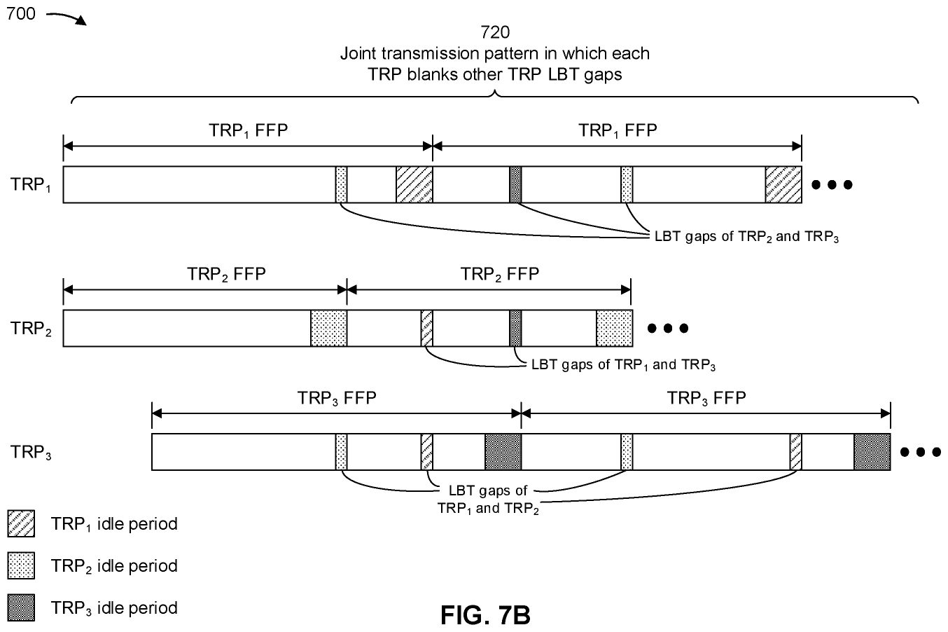

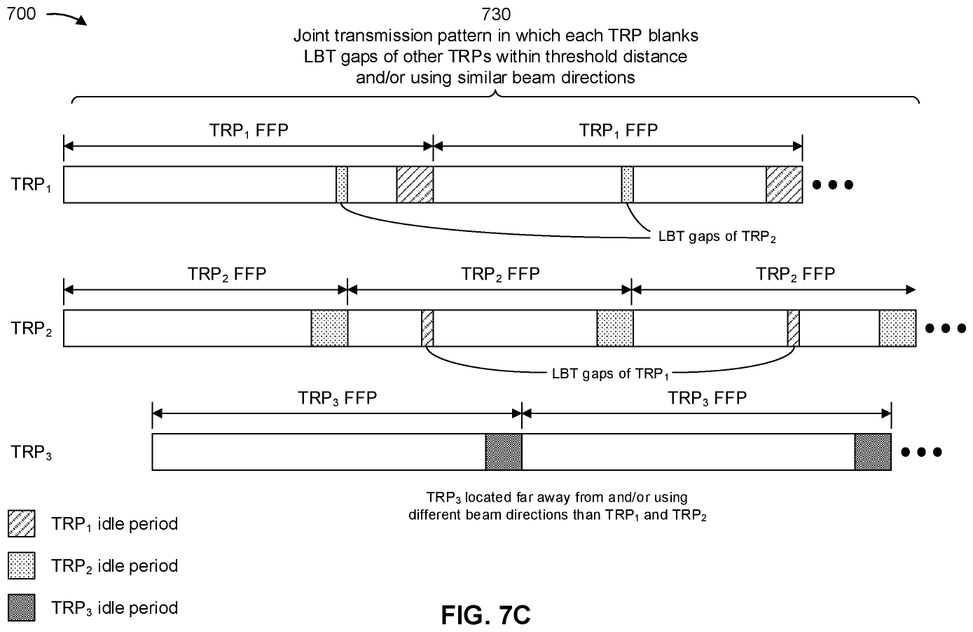

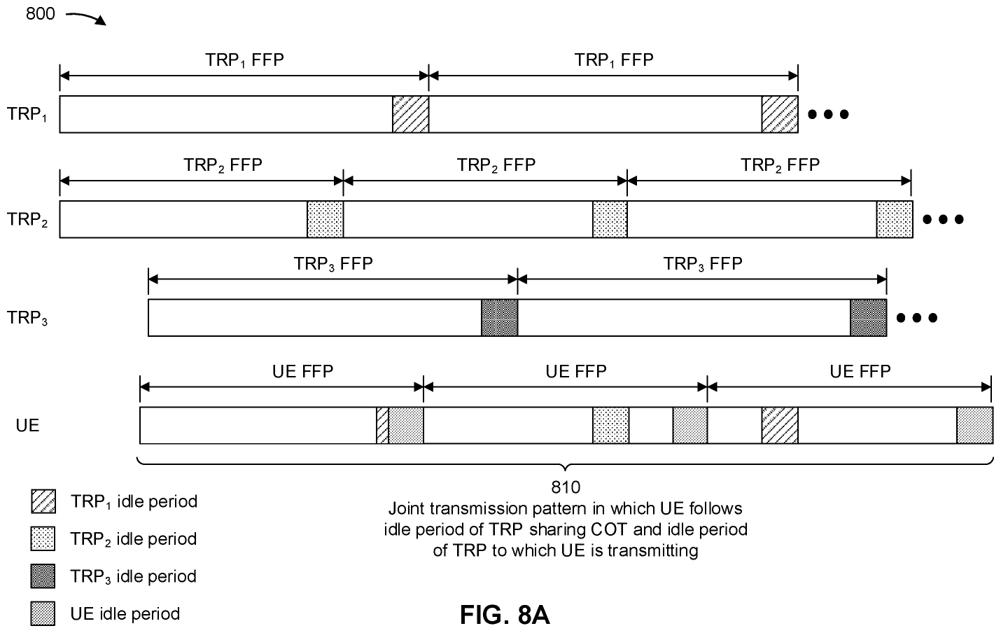

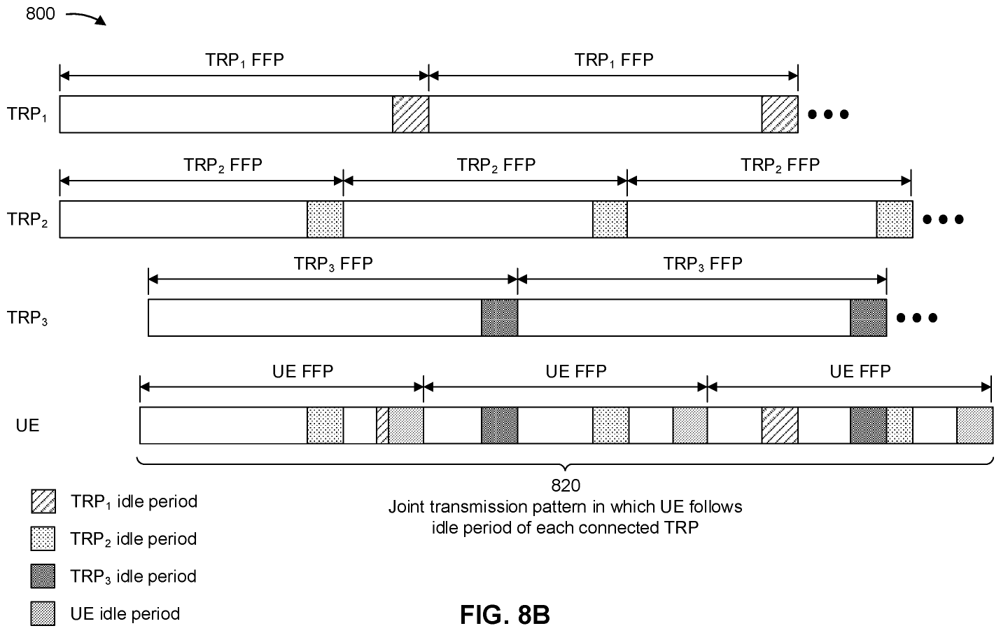

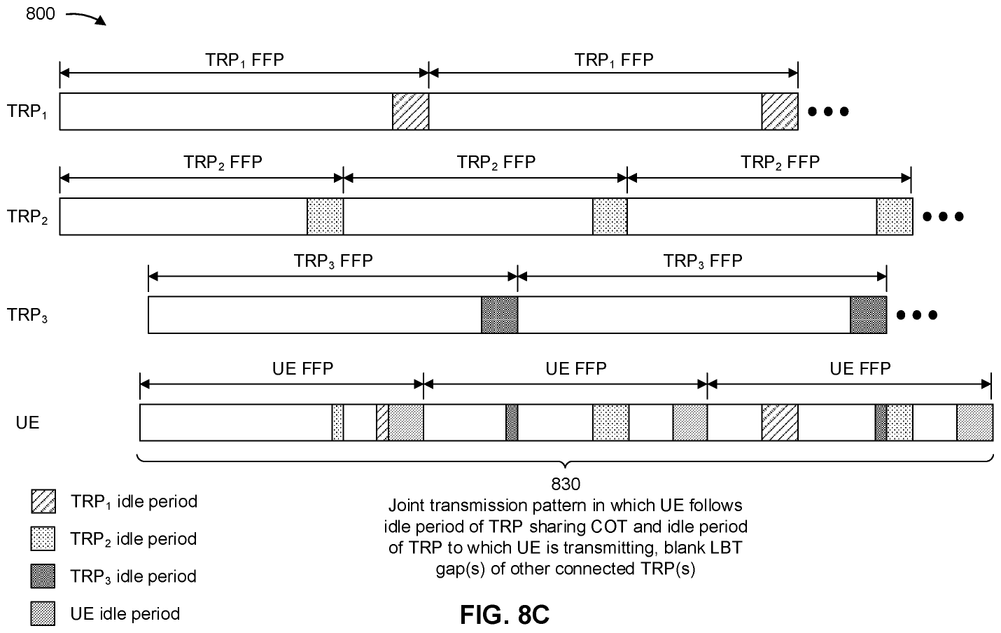

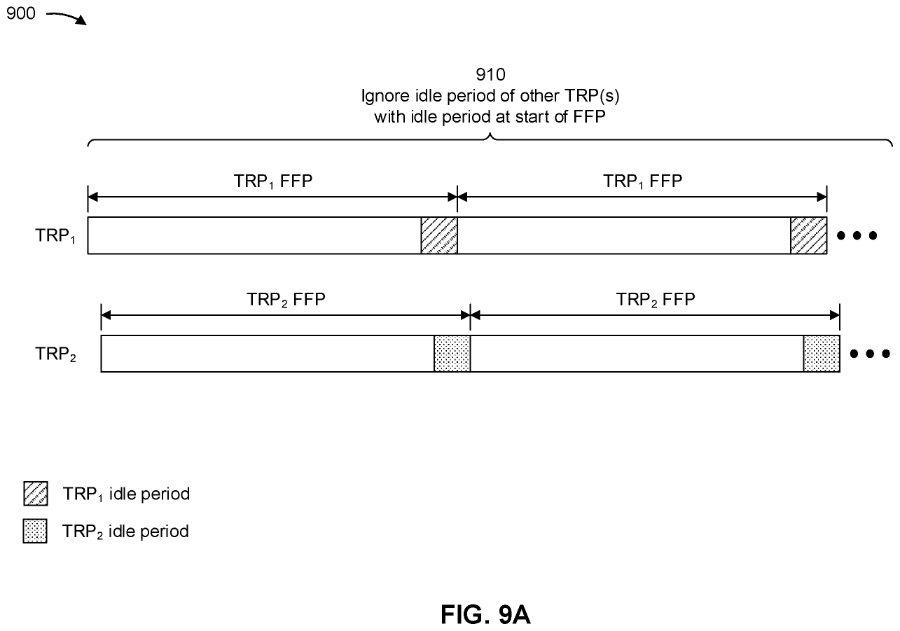

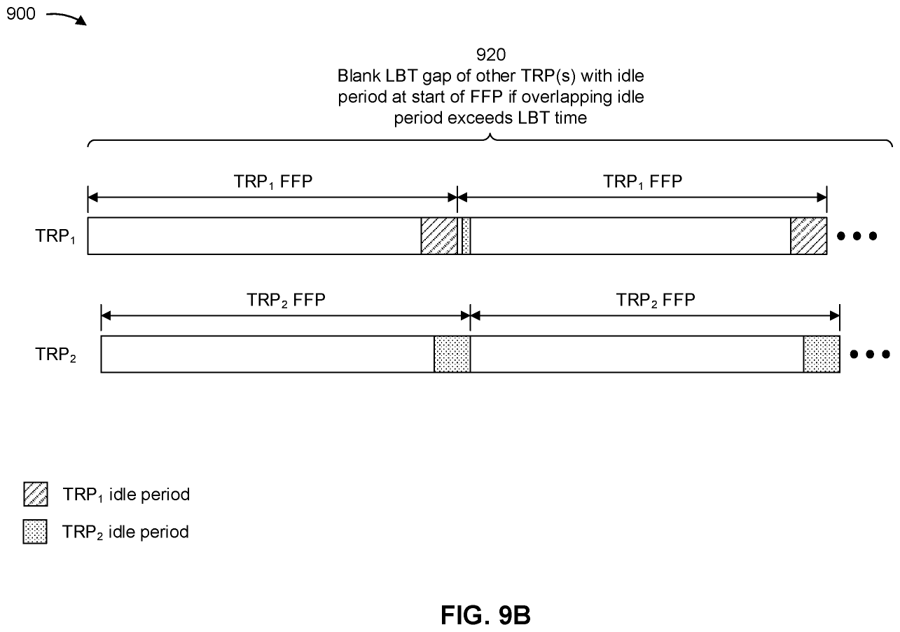

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (e.g., as described with reference to FIG. 6, FIGS. 7A-7C, FIGS. 8A-8C, and/or FIGS. 9A-9C).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (e.g., as described with reference to FIG. 6, FIGS. 7A-7C, FIGS. 8A-8C, and/or FIGS. 9A-9C).

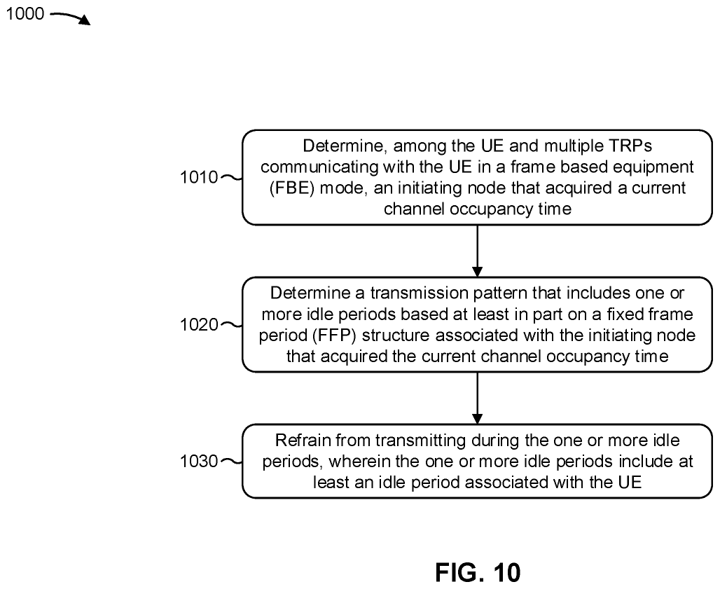

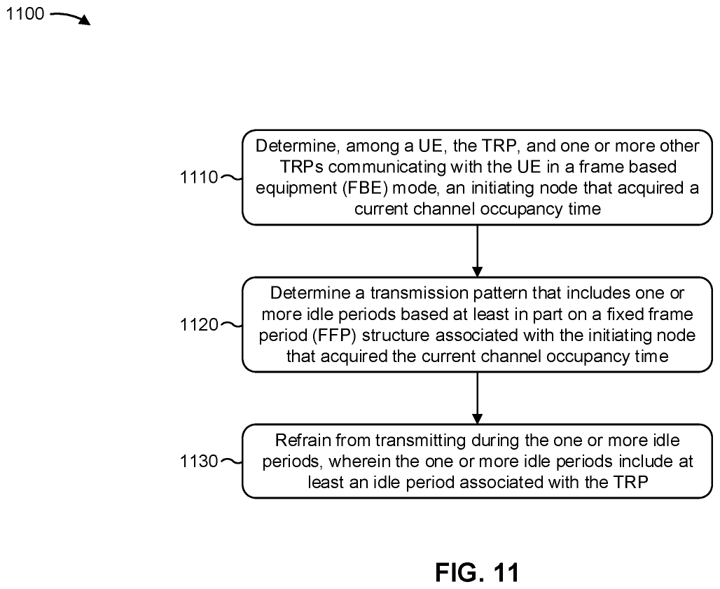

Controller/processor 240 of base station 110, controller/processor 280 of UE 120, and/or any other component(s) of FIG. 2 may perform one or more techniques associated with idle period handling for multiple TRP (mTRP) operation, as described in more detail elsewhere herein. In some aspects, a TRP as described herein is the base station 110, is included in the base station 110, or includes one or more components of the base station 110 shown in FIG. 2. For example, controller/processor 240 of base station 110, controller/processor 280 of UE 120, and/or any other component(s) of FIG. 2 may perform or direct operations of, for example, process 1000 of FIG. 10, process 1100 of FIG. 11, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1000 of FIG. 10, process 1100 of FIG. 11, and/or other processes as described herein. In some aspects, executing instructions may include running the instructions, converting the instructions, compiling the instructions, and/or interpreting the instructions, among other examples.

In some aspects, the UE 120 includes means for determining, among the UE 120 and multiple TRPs communicating with the UE 120 in a frame based equipment (FBE) mode, an initiating node that acquired a current channel occupancy time; means for determining a transmission pattern that includes one or more idle periods based at least in part on a fixed frame period (FFP) structure associated with the initiating node that acquired the current channel occupancy time; and/or means for refraining from transmitting during the one or more idle periods, wherein the one or more idle periods include at least an idle period associated with the UE 120. The means for the UE 120 to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, a TRP includes means for determining, among a UE 120, the TRP, and one or more other TRPs communicating with the UE 120 in an FBE mode, an initiating node that acquired a current channel occupancy time; means for determining a transmission pattern that includes one or more idle periods based at least in part on an FFP structure associated with the initiating node that acquired the current channel occupancy time; and/or means for refraining from transmitting during the one or more idle periods, wherein the one or more idle periods include at least an idle period associated with the TRP. In some aspects, the means for the TRP to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

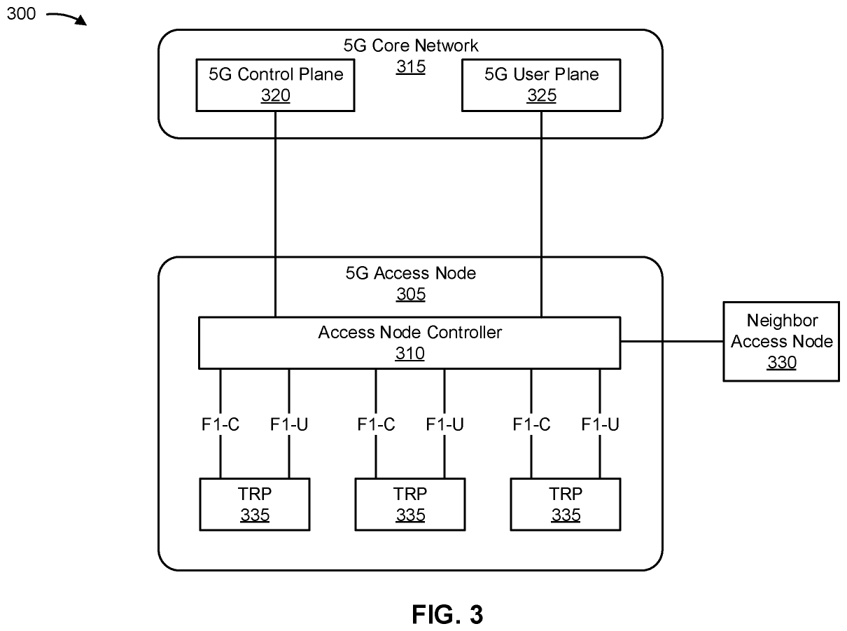

FIG. 3 illustrates an example logical architecture of a distributed radio access network (RAN) 300, in accordance with the present disclosure.

A 5G access node 305 may include an access node controller 310. The access node controller 310 may be a central unit (CU) of the distributed RAN 300. In some aspects, a backhaul interface to a 5G core network 315 may terminate at the access node controller 310. The 5G core network 315 may include a 5G control plane component 320 and a 5G user plane component 325 (e.g., a 5G gateway), and the backhaul interface for one or both of the 5G control plane and the 5G user plane may terminate at the access node controller 310. Additionally, or alternatively, a backhaul interface to one or more neighbor access nodes 330 (e.g., another 5G access node 305 and/or an LTE access node) may terminate at the access node controller 310.

The access node controller 310 may include and/or may communicate with one or more TRPs 335 (e.g., via an F1 Control (F1-C) interface and/or an F1 User (F1-U) interface). A TRP 335 may be a distributed unit (DU) of the distributed RAN 300. In some aspects, a TRP 335 may correspond to a base station 110 described above in connection with FIG. 1. For example, different TRPs 335 may be included in different base stations 110. Additionally, or alternatively, multiple TRPs 335 may be included in a single base station 110. In some aspects, a base station 110 may include a CU (e.g., access node controller 310) and/or one or more DUs (e.g., one or more TRPs 335). In some cases, a TRP 335 may be referred to as a cell, a panel, an antenna array, or an array.

A TRP 335 may be connected to a single access node controller 310 or to multiple access node controllers 310. In some aspects, a dynamic configuration of split logical functions may be present within the architecture of distributed RAN 300. For example, a packet data convergence protocol (PDCP) layer, a radio link control (RLC) layer, and/or a medium access control (MAC) layer may be configured to terminate at the access node controller 310 or at a TRP 335.

In some aspects, multiple TRPs 335 may transmit communications (e.g., the same communication or different communications) in the same transmission time interval (TTI) (e.g., a slot, a mini-slot, a subframe, or a symbol) or different TTIs using different QCL relationships (e.g., different spatial parameters, different transmission configuration indicator (TCI) states, different precoding parameters, and/or different beamforming parameters). In some aspects, a TCI state may be used to indicate one or more QCL relationships. A TRP 335 may be configured to individually (e.g., using dynamic selection) or jointly (e.g., using joint transmission with one or more other TRPs 335) serve traffic to a UE 120.

As indicated above, FIG. 3 is provided as an example. Other examples may differ from what is described with regard to FIG. 3.

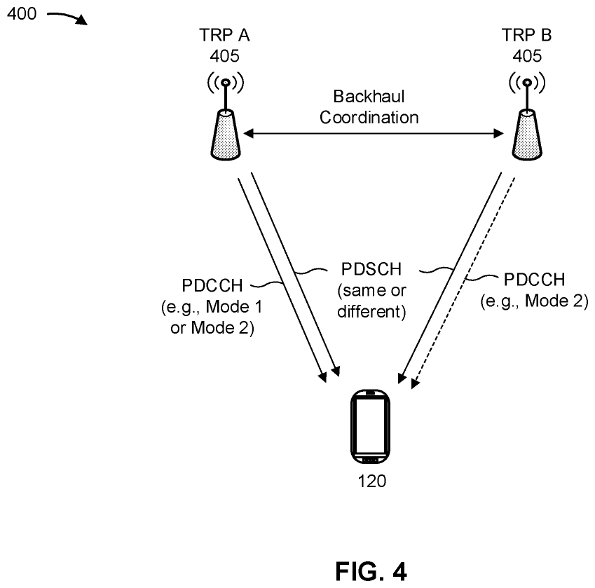

FIG. 4 is a diagram illustrating an example 400 of multiple transmit receive point (mTRP) communication (sometimes referred to as multi-panel communication), in accordance with the present disclosure. As shown in FIG. 4, multiple TRPs 405 may communicate with the same UE 120. A TRP 405 may correspond to a TRP 335 described above in connection with FIG. 3.

The multiple TRPs 405 (shown as TRP A and TRP B) may communicate with the same UE 120 in a coordinated manner (e.g., using coordinated multipoint transmissions) to improve reliability and/or increase throughput. The TRPs 405 may coordinate such communications via an interface between the TRPs 405 (e.g., a backhaul interface and/or an access node controller 310). The interface may have a smaller delay and/or higher capacity when the TRPs 405 are co-located at the same base station 110 (e.g., when the TRPs 405 are different antenna arrays or panels of the same base station 110), and may have a larger delay and/or lower capacity (as compared to co-location) when the TRPs 405 are located at different base stations 110. The different TRPs 405 may communicate with the UE 120 using different QCL relationships (e.g., different TCI states), different DMRS ports, and/or different layers (e.g., of a multi-layer communication).

In a first mTRP transmission mode (e.g., Mode 1), a single physical downlink control channel (PDCCH) may be used to schedule downlink data communications for a single physical downlink shared channel (PDSCH). In this case, multiple TRPs 405 (e.g., TRP A and TRP B) may transmit communications to the UE 120 on the same PDSCH. For example, a communication may be transmitted using a single codeword with different spatial layers for different TRPs 405 (e.g., where one codeword maps to a first set of layers transmitted by a first TRP 405 and maps to a second set of layers transmitted by a second TRP 405). As another example, a communication may be transmitted using multiple codewords, where different codewords are transmitted by different TRPs 405 (e.g., using different sets of layers). In either case, different TRPs 405 may use different QCL relationships (e.g., different TCI states) for different DMRS ports corresponding to different layers. For example, a first TRP 405 may use a first QCL relationship or a first TCI state for a first set of DMRS ports corresponding to a first set of layers, and a second TRP 405 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for mTRP transmission as discussed here) in this mTRP transmission mode (e.g., Mode 1).

In a second mTRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 405, and a second PDCCH may schedule a second codeword to be transmitted by a second TRP 405. Furthermore, first DCI (e.g., transmitted by the first TRP 405) may schedule a first PDSCH communication associated with a first set of DMRS ports with a first QCL relationship (e.g., indicated by a first TCI state) for the first TRP 405, and second DCI (e.g., transmitted by the second TRP 405) may schedule a second PDSCH communication associated with a second set of DMRS ports with a second QCL relationship (e.g., indicated by a second TCI state) for the second TRP 405. In this case, DCI (e.g., having DCI format 1_0 or DCI format 11) may indicate a corresponding TCI state for a TRP 405 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 4 is provided as an example. Other examples may differ from what is described with regard to FIG. 4.

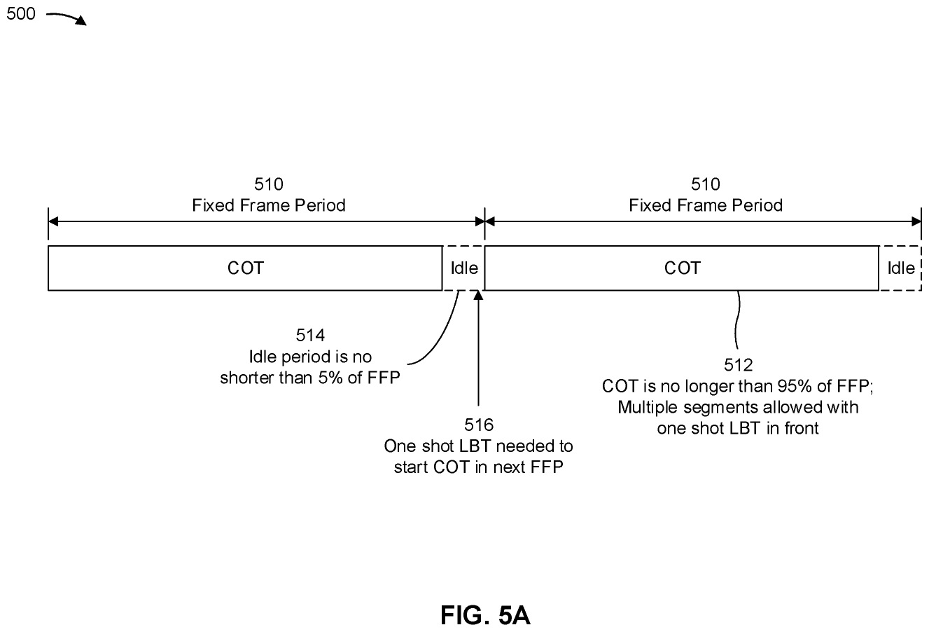

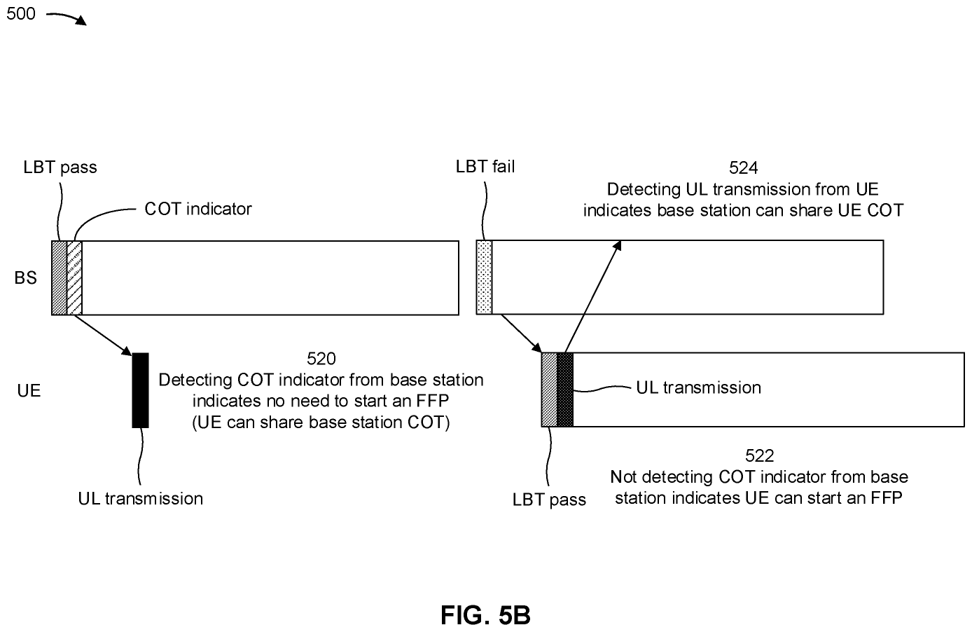

FIGS. 5A-5B are diagrams illustrating an example 500 of an FFP that includes a channel occupancy time during which one or more devices may conduct transmissions in an unlicensed channel, in accordance with the present disclosure.

To accommodate increasing traffic demands, there have been various efforts to improve spectral efficiency in wireless networks and thereby increase network capacity (e.g., via use of higher order modulations, advanced MIMO antenna technologies, and/or multi-cell coordination techniques, among other examples). Another way to potentially improve network capacity is to expand system bandwidth. However, available spectrum in lower frequency bands that have traditionally been licensed or otherwise allocated to mobile network operators has become very scarce. Accordingly, various technologies have been developed to enable a cellular radio access technology (RAT) to operate in unlicensed or other shared spectrum. For example, Licensed-Assisted Access (LAA) uses carrier aggregation on a downlink to combine LTE in a licensed frequency band with LTE in an unlicensed frequency band (e.g., the 2.4 and/or 5 GHz bands already populated by wireless local area network (WLAN) or “Wi-Fi” devices). In other examples, Enhanced LAA (eLAA) and Further Enhanced LAA (feLAA) technologies enable both uplink and downlink LTE operation in unlicensed spectrum, MulteFire is an LTE-based technology that operates in unlicensed and shared spectrum in a standalone mode, and NR-U enables NR operation in unlicensed spectrum, among other examples.

For example, in some cases, an unlicensed radio frequency (RF) band (e.g., the 6 gigahertz (GHz) unlicensed RF band or the 60 GHz unlicensed RF band) may span a frequency range and may utilize frequency division duplexing (FDD). In an FDD system, a first band (e.g., a first sub-band of the unlicensed RF band) may be used for downlink communication, and a second band (e.g., a second sub-band of the unlicensed RF band) may be used for uplink communication. As used herein, “downlink communication” may refer to communication from a control node to a downstream node (e.g., a node that is controlled, configured, and/or scheduled by the control node), such as from a base station 110 or a TRP 335, 405 to a UE 120, and/or from a WLAN access point to a WLAN station, among other examples. Furthermore, as used herein, “uplink communication” may refer to communication from the downstream node to the control node, such as from a UE 120 to a base station 110 or a TRP 320, 405, and/or from a WLAN station to a WLAN access point, among other examples.

In some aspects, in cases where an unlicensed RF band utilizes FDD, the downlink band may be divided into multiple downlink channels, sometimes referred to as downlink frequency channels. Similarly, the uplink band may be divided into multiple uplink channels, sometimes referred to as uplink frequency channels. In some aspects, each downlink channel may correspond to a single uplink channel, which may be referred to as channel pairing (e.g., where a downlink channel is paired with an uplink channel). In such a configuration, a control node and a downstream node may use a particular downlink channel for downlink communication, and may use a particular uplink channel, that is paired with or corresponds to the particular downlink channel, for uplink communication.

Alternatively, in some aspects, an unlicensed communication channel may utilize time division duplexing (TDD). For example, in an unlicensed communication channel that utilizes TDD, uplink and downlink transmissions may be separated in time and may be conducted on the same frequency channel. However, unlike TDD in licensed spectrum, a subframe, a slot, a symbol, and/or another TTI is not restricted to being configured for uplink communication or downlink communication, and may be configured for downlink transmissions by a base station or TRP or for uplink transmissions by a UE. Furthermore, unlicensed communication may support dynamic TDD, where an uplink-downlink allocation may change over time to adapt to traffic conditions. For example, to enable dynamic TDD, a wireless device (e.g., a base station, a TRP, or a UE) may determine when to transmit, and in which resource to transmit, according to an indication of a channel occupancy time structure. In general, the channel occupancy time may include multiple TTIs (e.g., multiple slots), and each TTI may include one or more downlink resources, one or more uplink resources, and/or one or more flexible resources. In this way, the channel occupancy time structure reduces power consumption and/or channel access delay.

In an unlicensed RF band, all or a portion of the frequency band may be licensed to entities referred to as fixed service incumbents. Accordingly, when a cellular RAT is operated in unlicensed spectrum (e.g., using LAA, eLAA, feLAA, MulteFire, and/or NR-U), one challenge that arises is the need to ensure fair coexistence with incumbent (e.g., WLAN) devices that may be operating in the unlicensed spectrum. For example, regulations may specify that a transmitting device (e.g., a base station 110, a TRP 335 or 405, and/or UE 120) is to perform a listen-before-talk (LBT) procedure to contend for access to an unlicensed channel prior to gaining access to and/or transmitting over the unlicensed channel. The LBT procedure may include a clear channel assessment (CCA) procedure to determine whether the unlicensed channel is available (e.g., unoccupied by other transmitters). In particular, a device performing a CCA procedure may detect an energy level on an unlicensed channel and determine whether the energy level satisfies (e.g., is less than or equal to) a threshold, sometimes referred to as an energy detection threshold. When the energy level satisfies (e.g., is below) the threshold, the LBT procedure is deemed to be successful and the transmitting device may gain access to the unlicensed channel for a duration referred to as a channel occupancy time. During the channel occupancy time, the transmitting device can perform one or more transmissions without having to perform any additional LBT operations. However, when the energy level fails to satisfy (e.g., equals or exceeds) the energy detection threshold, the LBT procedure fails and contention to access the unlicensed channel by the transmitting device is unsuccessful.

In cases where the LBT procedure fails because the CCA procedure results in a determination that the unlicensed channel band is unavailable (e.g., because the energy level detected on the unlicensed channel exceeds the energy detection threshold, indicating that another device is already using the channel), the CCA procedure may be performed again at a later time. In environments in which the transmitting device may be starved of access to an unlicensed channel (e.g., due to WLAN activity or transmissions by other devices), an extended CCA (eCCA) procedure may be employed to increase the likelihood that the transmitting device will successfully obtain access to the unlicensed channel. For example, a transmitting device performing an eCCA procedure may perform a random quantity of CCA procedures (from 1 to q), in accordance with an eCCA counter. If and/or when the transmitting device senses that the channel has become clear, the transmitting device may start a random wait period based on the eCCA counter and start to transmit if the channel remains clear over the random wait period.

In a wireless network that supports communication in unlicensed spectrum, an LBT procedure may be performed in either a load based equipment (LBE) mode or a frame based equipment (FBE) mode. In the LBE mode, a transmitting device may perform channel sensing in association with an LBT procedure at any time, and a random backoff is used in cases where the unlicensed channel is found to be busy. In the FBE mode, a base station may perform channel sensing in association with an LBT procedure at fixed time instances, and the base station waits until a fixed time period has elapsed before sensing the unlicensed channel again in cases where the unlicensed channel is found to be busy. In particular, the fixed time instances when the base station performs channel sensing may be defined according to a fixed frame period (FFP).

For example, FIG. 5A depicts an example FFP 510 that a base station may use to communicate in unlicensed spectrum. As shown in FIG. 5A, the FFP 510 may include a channel occupancy time (COT) 512 during which the base station may transmit one or more downlink communications. In some cases, as described below with reference to FIG. 5B, the base station may share the channel occupancy time 512 with a UE, which may enable the UE to transmit one or more uplink communications during the channel occupancy time 512 that is initiated by the base station and shared with the UE. As shown in FIG. 5A, the FFP 510 may further include an idle period 514 (sometimes referred to as a gap period) at an end of the FFP 510, after the channel occupancy time 512. The idle period 514 of the FFP 510 provides time to perform an LBT procedure prior to a next FFP 510. The FFP 510, including the channel occupancy time 512 and the idle period 514, may have a duration of 1 millisecond (ms), 2 ms, 2.5 ms, 4 ms, 5 ms, or 10 ms. Within every two radio frames (e.g., even-numbered radio frames), starting positions of the FFPs 510 may be given by i*P, where i={0, 1, . . . , 20/P−1} and P is the duration of the FFP 510 in milliseconds. For a given subcarrier spacing (SCS), the idle period 514 is a ceiling value for a minimum idle period allowed by regulations, divided by Ts, where the minimum duration of the idle period 514 is a maximum of 100 microseconds (μs) and 5% of the duration of the FFP 510, and Ts is the symbol duration for the given SCS. Accordingly, the idle period 514 may occupy no less than 5% of the duration of the FFP 510, and the channel occupancy time 512 may occupy no more than 95% of the duration of the FFP 510.

In FBE mode, an FFP configuration may be indicated in a system information block (e.g., SIB-1) or signaled to a UE in UE-specific radio resource control (RRC) signaling (e.g., for an FBE secondary cell use case). If the network indicates that FBE mode is to be used for fallback downlink and/or uplink grants, for an indication of Category 2 LBT (25 μs) (e.g., LBT without random backoff) or Category 4 LBT (e.g., LBT with random backoff and a variable size contention window), the UE may perform channel sensing measurements in one 9 μs slot (e.g., one shot LBT) within a 25 μs interval, which may be referred to herein as an LBT gap. UE transmissions within the FFP 510 may occur if the UE detects one or more downlink transmissions within the FFP 510 (e.g., a PDCCH, a synchronization signal block (SSB), a physical broadcast channel (PBCH), remaining minimum system information (RMSI), a group common PDCCH (GC-PDCCH), and/or another suitable downlink signal or downlink channel). The same 2-bit field may be used in LBE mode and FBE mode to indicate an LBT type, a cyclic prefix extension, and/or a channel access priority class (CAPC) indication.

In Release 16 NR unlicensed (NR-U) FBE mode, only a base station can act as an initiating device to acquire a channel occupancy time 512, and a UE may act only as a responding device (e.g., sharing a channel occupancy time 512 acquired by a base station). In NR-U FBE mode, channel access rules may therefore be as follows. If the base station is to initiate a channel occupancy time 512, a Category 1 (Cat-1) LBT procedure may not apply and the base station may perform a Category 2 (Cat-2) LBT procedure in the idle period 514, during an LBT gap just prior to an FFP 510. If the base station is to transmit a downlink burst in the channel occupancy time 512, the base station may perform a Cat-1 LBT procedure (e.g., no LBT) if a gap from a previous downlink burst or a previous uplink burst is within 16 μs, and may otherwise perform a Cat-2 LBT procedure if the gap is more than 16 μs. If the UE is to transmit an uplink burst in a channel occupancy time 512 that is acquired by the base station and shared with the UE, the UE may perform a Cat-1 LBT procedure if the gap from the previous downlink or uplink burst is within 16 μs, and may otherwise perform the Cat-2 LBT procedure if the gap is greater than 16 μs. Notably, the Cat-2 LBT procedure for FBE mode may be different from the Cat-2 LBT procedure (25 μs or 16 μs) in LBE mode. In some aspects, one 9 μs measurement right before the transmission may be needed, with at least 4 μs for measurement. As shown by reference number 516, the 9 μs measurement needed to start a channel occupancy time 512 in a next FFP 510 may be referred to as an LBT gap or a one-shot LBT. However, neither the Cat-1 LBT procedure nor the Cat-2 LBT procedure applies in cases where the UE is to initiate a channel occupancy time in FBE mode, because a UE cannot initiate a channel occupancy time in Release 16 NR-U FBE mode.

Accordingly, although a wireless network can be configured to use unlicensed spectrum to achieve faster data rates, provide a more responsive user experience, and/or offload traffic from licensed spectrum, among other examples, one limitation in FBE mode is that a UE cannot initiate a channel occupancy time to perform uplink transmissions. Accordingly, in order to improve access, efficiency, and/or latency for an unlicensed channel, a wireless network may permit a base station to share a channel occupancy time with a UE. For example, as shown in FIG. 5B, and by reference number 520, a base station may transmit a COT indicator to one or more UEs (e.g., using group common DCI) in cases where the base station successfully contends for access to an unlicensed channel (e.g., by performing an LBT procedure that passes), and the COT indicator from the base station may indicate that the one or more UEs do not need to start an FFP. Instead, the one or more UEs can share the channel occupancy time acquired by the base station and transmit one or more uplink communications during the shared channel occupancy time.

In a fully controlled environment, permitting only the base station to contend for access to the unlicensed channel and share a channel occupancy time initiated by the base station with one or more UEs may be sufficient. For example, a “fully controlled” environment may refer to an environment that is restricted or otherwise controlled such that no other RAT or operators are operating in the coverage area. Consequently, in a fully controlled environment, an LBT procedure may always pass, even in FBE mode. In practice, however, a fully controlled environment may be difficult to achieve because there may be a chance that some other RAT is operating even in cases where the environment is supposedly cleared. For example, an employee working on an otherwise cleared factory floor may be carrying a WLAN station that transmits a WLAN access probe even though no WLAN access points are deployed in the environment. Accordingly, in an almost fully controlled environment, there is a small chance that an LBT procedure performed by a base station will fail, which may result in unacceptable performance for services having stringent quality of service requirements (e.g., ultra-reliable low-latency communication (URLLC) and/or industrial internet of things (IIoT) applications). For example, even in cases where an LBT failure rate is as low as 10⁻³, there is a 10⁻³ probability that a URLLC packet scheduled to be delivered in an FFP cannot be delivered because both the base station and any UE(s) in communication with the base station have to surrender the entire FFP due to failure of an LBT procedure performed by the base station at the beginning of the FFP. The 10⁻³ failure probability may be insufficient to satisfy a URLLC reliability requirement, which typically requires a reliability of 10⁻⁶ or better. Furthermore, these problems are exacerbated in uncontrolled environments where there may be many incumbent and/or competing devices contending for access to the unlicensed channel.

Accordingly, in cases where only a base station can contend for access to an unlicensed channel in FBE mode, a UE may be unable to transmit on an uplink if an LBT procedure performed by the base station fails and/or the base station does not perform an LBT procedure to acquire a channel occupancy time that can be shared with the UE (e.g., because the base station does not have downlink data to transmit). Consequently, a UE may be permitted to act as an initiating device to perform an LBT procedure and acquire a channel occupancy time in the FBE mode in cases where the base station fails the LBT procedure or the UE otherwise does not detect a COT indicator from the base station (e.g., because the base station did not perform the LBT procedure due to a lack of downlink activity and/or due to impairments in a wireless channel interfering with downlink detection, among other examples). For example, as shown by reference number 522, the UE may perform an LBT procedure to start an FFP and initiate a COT in which to transmit one or more uplink communications in cases where the UE does not detect a COT indicator from the base station. Accordingly, as further shown by reference number 524, the UE may transmit one or more uplink communications over the unlicensed channel if the LBT procedure passes, and detecting the uplink transmission from the UE may indicate to the base station that the base station can share the channel occupancy time acquired by the UE to perform downlink transmissions.

In some aspects, allowing the UE to initiate a channel occupancy time in FBE mode may improve access to the unlicensed channel, reduce uplink latency, conserve power, and/or reduce interference. For example, when the UE initiates a channel occupancy time, the UE can use the channel occupancy time to transmit a physical random access channel (PRACH) for initial network access. In particular, during initial network access, the UE may not yet be configured with a system information radio network temporary identifier (SI-RNTI) or another known RNTI used to monitor for a downlink transmission (e.g., DCI scrambled with the SI-RNTI or other known RNTI) to determine whether the base station has acquired a channel occupancy time. This may restrict the ability of the UE to transmit a PRACH for initial network access. Accordingly, enabling the UE to initiate a channel occupancy time may enable uplink PRACH transmissions (or other uplink transmissions) before the UE has been configured to monitor for downlink transmissions from the base station.

Furthermore, allowing the UE to initiate a channel occupancy time enables the UE to transmit a physical uplink control channel (PUCCH) and/or a physical uplink shared channel (PUSCH) earlier in an FFP associated with a base station (e.g., reducing uplink latency). For example, when sharing a channel occupancy time acquired by a base station, the UE has to confirm that the base station acquired the channel occupancy time by detecting downlink activity in an earlier portion of the FFP in order to enable transmissions in a later portion of the FFP (e.g., the UE needs to leave time in the earlier portion of the base station FFP to allow time for the downlink transmission from the base station and/or time for the UE to process the downlink transmission). Furthermore, allowing the UE to initiate a channel occupancy time may save power at the base station and/or reduce interference over the unlicensed channel. For example, in order to share a channel occupancy time and enable uplink transmission within the shared channel occupancy time, the base station needs to actively transmit one or more downlink communications in the earlier portion of the FFP, even if the base station does not have a need to transmit the downlink communication(s). This may result in additional power consumption at the base station and extra interference on the unlicensed channel, which can be avoided by allowing the UE to initiate a channel occupancy time. Furthermore, allowing the UE to initiate a channel occupancy time rather than relying on sharing a channel occupancy time acquired by the base station may avoid problems that may otherwise arise where downlink signal detection has a reliability limitation.

Although allowing a UE to initiate a channel occupancy time during which the UE can conduct uplink transmissions over an unlicensed channel can improve channel access, reduce uplink latency, conserve power, reduce interference, and/or the like, challenges may arise in cases where a base station and one or more UEs initiate (or attempt to initiate) a channel occupancy time for the same unlicensed channel. For example, an FFP that is configured for a UE that is allowed to initiate a channel occupancy time in FBE mode may generally have a start time that is offset from a start time of the FFP that is configured for the base station. Otherwise, if the FFP configured for the UE were to start at the same time as the FFP configured for the base station, the UE and the base station may each contend for access to the unlicensed channel at the same time (e.g., by performing an LBT procedure in the idle period prior to the FFP at the same time), which may result in the base station and the UE failing to detect one another. Furthermore, because the FFP configured for the base station and the FFP configured for the UE are both required by regulation to have an idle period at the end of the FFP, the idle period in the FFP configured for the base station would not be aligned with the idle period in the FFP configured for the UE. Consequently, in cases where the base station and the UE both successfully acquire a channel occupancy time, the base station may transmit in the channel occupancy time of the FFP configured for the base station during the idle period of the FFP configured for the UE, and vice versa.

In other words, due to the offset between the UE FFP and the base station FFP (and resulting unaligned idle periods), the base station channel occupancy time may overlap with the UE idle period and the UE channel occupancy time may overlap with the base station idle period. As a result, each node may transmit during the idle period of the other node without leaving a gap that is long enough for other devices (e.g., LBE devices) to perform a Cat-4 LBT procedure and acquire the unlicensed channel, which could starve other devices and/or other RATs from accessing the unlicensed channel. Accordingly, one technique to ensure that a base station refrains from transmitting during the idle period of a UE and to ensure that a UE refrains from transmitting during the idle period of a base station is to configure the base station and the UE to follow an FFP associated with an initiating node that acquired a channel occupancy time. For example, in cases where a node is initiating a channel occupancy time at a given time, the node may refrain from transmitting during the idle period of the FFP that is configured for the initiating node. Furthermore, in cases where the initiating node shares the channel occupancy time with a responding node, the responding time may refrain from transmitting during the idle period of the FFP configured for the initiating node. For example, if a base station acquires a channel occupancy time and shares the channel occupancy time with a UE, the base station and the UE may each refrain from transmitting during the idle period of the FFP configured for the base station.

In general, the approach of having devices follow the FFP of the device that initiated the channel occupancy time may improve channel access in cases where a UE communicates with a single base station. For example, because the base station has one FFP structure, configuring the base station to refrain from transmitting during the idle period of a UE FFP when the UE initiates a channel occupancy time and configuring the UE to refrain from transmitting during the idle period of a base station FFP when the base station initiates a channel occupancy time may ensure that neither node transmits during the idle period of the other node. However, when the UE is configured for mTRP operation (e.g., as described above with reference to FIG. 4), the UE may generally connect to multiple TRPs that may have the same or different FFP structures (e.g., the same duration and offset, different durations, and/or different offsets, among other examples). In such cases, the multiple TRPs and the UE(s) connected to the multiple TRPs may need to know which FFP structure should be used and/or the idle period(s) during which to refrain from transmitting, which may vary depending on whether a current channel occupancy time is initiated by the UE or a TRP and/or depending on which of the multiple TRPs initiated the current channel occupancy time. Otherwise, one or more nodes may transmit during the idle period(s) of other nodes, which may block the other nodes from performing a successful LBT procedure and/or block other RATs from accessing the unlicensed channel.

Some aspects described herein relate to techniques and apparatuses for configuring a transmission pattern that includes one or more idle periods for a UE and/or multiple TRPs that are communicating in an FBE mode (e.g., using an FFP structure with a channel occupancy time followed by an idle period). For example, in some aspects, the multiple TRPs may be configured with a common FFP structure (e.g., the same period and offset) such that the idle periods of the multiple TRPs are aligned in time. In such cases, the UE and the multiple TRPs may determine whether the UE or a TRP initiated a current channel occupancy time, and the UE and the multiple TRPs may follow the FFP of the node that initiated the current channel occupancy time. Additionally, or alternatively, a joint transmission pattern may be configured across the TRPs and the UE to prevent the UE from transmitting during the TRP idle period when the UE is the initiating node, or vice versa. For example, the TRPs may refrain from transmitting during the idle period and/or the LBT gap of the UE, and the UE may refrain from transmitting during the idle period and/or the LBT gap of the TRPs, which may provide each node with an opportunity to initiate a channel occupancy time. In some aspects, in cases where the multiple TRPs have different FFP structures (e.g., different periods and/or offsets), the UE and the multiple TRPs may be configured to follow a transmission pattern in which one or more idle periods include an idle period of the node that initiated the channel occupancy time. Additionally, or alternatively, the TRPs may blank (e.g., refrain from transmitting during) the idle period and/or the LBT gaps of one or more other TRPs such that the other TRPs can access the unlicensed channel, and similar rules may be applied by the UE (e.g., the UE may refrain from transmitting during the idle period(s) and/or LBT gap(s) of one or more of the multiple TRPs, which may include all of the TRPs, a TRP sharing a channel occupancy time with the UE, and/or a TRP to which the UE is transmitting, among other examples).

As indicated above, FIGS. 5A-5B are provided as an example. Other examples may differ from what is described with regard to FIGS. 5A-5B.

FIG. 6 is a diagram illustrating an example 600 associated with idle period handling for mTRP operation where multiple TRPs share a common FFP structure, in accordance with the present disclosure. For example, as described herein, multiple TRPs (e.g., TRPs 335 and/or TRPs 405, shown as TRP₁ . . . TRP_{N}) may communicate with a UE (e.g., UE 120 and/or the like) in a wireless network (e.g., wireless network 100) using one or more unlicensed channels in FBE mode. In some aspects, as described herein, the TRPs and the UE may be allowed to initiate a channel occupancy time in FBE mode, and an FFP structure configured for the UE may have a start time that is offset from a start time of the common FFP structure that is configured for the multiple TRPs. Furthermore, as described herein, the UE and the TRPs may each determine a transmission pattern that includes one or more idle periods to ensure that there are one or more silent periods during which no device is transmitting, such that other devices (e.g., LBE devices) may successfully contend for access to the unlicensed channel(s).

In some aspects, as shown by reference number 610, the multiple TRPs and the UE may follow an FFP structure of an initiating node that acquired a current channel occupancy time. For example, the UE and the TRPs may determine, among the UE and the multiple TRPs, an initiating node that acquired the current channel occupancy time, and may determine a transmission pattern that includes one or more idle periods according to the FFP structure associated with the initiating node. For example, in cases where the UE is the initiating node that acquired the channel occupancy time and the TRPs are responding nodes sharing the channel occupancy time acquired by the UE, the UE may refrain from transmitting during the idle period of the FFP structure associated with the UE, and the TRPs may refrain from transmitting during the idle period of the FFP structure associated with the UE in addition to the idle period of the FFP structure associated with the TRPs. Similarly, in cases where a TRP is the initiating node and the UE and the other TRPs are responding nodes sharing the channel occupancy time, each device may refrain from transmitting during the idle period of the common FFP structure associated with the TRPs, and the UE may further refrain from transmitting during the idle period of the FFP structure associated with the UE.

Additionally, or alternatively, a joint transmission pattern that includes one or more idle periods may be configured across the multiple TRPs and the UE to ensure that no device is blocked from initiating a channel occupancy time. For example, in cases where the UE initiates the current channel occupancy time, the TRPs may refrain from transmitting during the idle period of the FFP structure associated with the UE, but the UE may be permitted to transmit to the TRPs during the idle period shared by the multiple TRPs, which may block the TRPs from initiating a channel occupancy time. Similarly, in cases where a TRP initiates the current channel occupancy time, the UE may refrain from transmitting during the common idle period shared by the multiple TRPs, but the TRPs may be permitted to transmit to the UE during the idle period of the FFP structure associated with the UE. Accordingly, in order to allow each node an opportunity to initiate a channel occupancy time, the TRPs may blank (e.g., refrain from transmitting during) the idle period of the UE and/or any other UEs that may be connected to the TRPs, and the UE may blank the idle period of the TRPs.

While such an approach may provide each node with an opportunity to contend for access to the unlicensed channel, having the TRPs blank the idle period of the UE and/or any other UEs connected to the TRPs may result in the TRPs being unable to transmit during most (if not all) of the FFP. For example, if there are several UEs connected to the TRPs with different FFP offsets and/or periods, the idle periods of the UEs may overlap with a significant portion of the FFP associated with the TRPs and thereby block the TRPs from transmitting. Accordingly, in some aspects, the transmission pattern that the TRPs follow may include one or more idle periods that cover only an LBT gap of the UE and/or any other UEs connected to the TRPs. In this way, the UEs may still have an opportunity to perform a successful LBT procedure to initiate a channel occupancy time, and the TRPs can transmit during at least a portion of the UE idle period(s) leading up to the LBT gap(s). Alternatively, in some aspects, the joint transmission pattern that is configured for the multiple TRPs may be determined independently from the idle period of the UE. For example, in some cases, the FFP structure associated with the TRPs may have a longer channel occupancy time than the FFP structure associated with the UE and/or traffic may be downlink heavy, whereby the TRPs may ignore the idle period of the UE such that a TRP-initiated channel occupancy time is prioritized over a UE-initiated channel occupancy time.

As indicated above, FIG. 6 is provided as an example. Other examples may differ from what is described with regard to FIG. 6.

FIGS. 7A-7C are diagrams illustrating examples 700 associated with TRP behavior related to idle period handling for mTRP operation where multiple TRPs have different FFP structures, in accordance with the present disclosure. For example, as described herein, multiple TRPs (e.g., TRPs 335 and/or TRPs 405, shown as TRP₁, TRP₂, and TRP₃) may communicate with a UE (e.g., UE 120 and/or the like) in a wireless network (e.g., wireless network 100) using one or more unlicensed channels in FBE mode. In some aspects, as described herein, the TRPs and the UE may be allowed to initiate a channel occupancy time in FBE mode, and the TRPs may be configured with different FFP structures (e.g., different start times and/or different offsets). Consequently, if the idle periods of a first TRP and a second TRP are misaligned (e.g., the idle period of the first TRP coincides with the channel occupancy time of the second TRP and vice versa), the TRPs may occupy the unlicensed channel continuously and block other devices (e.g., LBE devices and/or other RATs) from accessing the unlicensed channel. Accordingly, as described herein, the TRPs may determine a transmission pattern that includes one or more idle periods to ensure that there are one or more silent periods during which no TRP is transmitting, such that other devices (e.g., the UE or LBE devices) may successfully access the unlicensed channel(s).

For example, in some aspects, each TRP may determine a transmission pattern that includes one or more idle periods associated with an initiating node that acquired a current channel occupancy time. For example, if a TRP is an initiating node that acquired the current channel occupancy time, the TRP may refrain from transmitting during the idle period of the FFP associated with the TRP. On the other hand, if a first TRP is a responding node sharing a current channel occupancy time that was acquired by a second TRP with a different FFP structure, the first TRP may refrain from transmitting during the idle period of the FFP associated with the second TRP. Additionally, or alternatively, a joint transmission pattern may be configured such that each TRP is configured to follow a transmission pattern that includes one or more silent (e.g., idle) periods during which no TRP is transmitting.

For example, as shown in FIG. 7A, and by reference number 710, the multiple TRPs may be configured to follow a joint transmission pattern in which each TRP honors (refrains from transmitting during) the idle period of all other TRPs. In other words, each TRP follows the idle period of each other TRP. For example, in FIG. 7A, TRP₁, TRP₂, and TRP₃ are configured with different FFP structures that have non-overlapping idle periods, and each TRP may refrain from transmitting during its own idle period as well as the idle periods of the other TRPs. In this way, all of the TRPs are silent during each idle period, ensuring that each device has an opportunity to perform an LBT procedure after the current channel occupancy time in order to attempt to initiate a channel occupancy time in a next FFP. However, configuring each TRP to blank every TRP idle period may result in significant resource consumption (e.g., turning transmit circuitry off and on in each idle period) and may reduce spectral efficiency because none of the TRPs can transmit during any TRP idle period.

Accordingly, as shown in FIG. 7B, and by reference number 720, the multiple TRPs may be configured to follow a joint transmission pattern in which each TRP refrains from transmitting during its own idle period in addition to blanking the LBT gap of all other TRPs. For example, as described above, the idle period may include an LBT gap just prior to a next FFP during which time a Cat-2 or Cat-4 LBT procedure may be performed to initiate a channel occupancy time in a next FFP. Accordingly, each TRP may refrain from transmitting during its own idle period, and may further refrain from transmitting during at least the LBT gaps of the other TRPs. For example, as shown in FIG. 7B, TRP₁ may remain silent during the LBT gaps of TRP₂ and TRP₃ in addition to its own idle period, TRP₂ may remain silent during the LBT gaps of TRP₁ and TRP₃ in addition to its own idle period, and TRP₃ may remain silent during the LBT gaps of TRP₁ and TRP₂ in addition to its own idle period. Additionally, or alternatively, the behavior of each TRP may vary depending on whether the respective TRP is an initiating node that acquired a current channel occupancy time or a responding node that is sharing a current channel occupancy time acquired by another TRP. For example, a TRP that is acting as an initiating node may follow its own idle period in addition to blanking the LBT gaps that occur just prior to the start of the FFPs for the other TRPs. Furthermore, a TRP that is acting as a responding node may follow its own idle period and the idle period of the TRP sharing the current channel occupancy time, while blanking the LBT gap(s) at the end of the FFP(s) associated with any other TRP(s).

In some aspects, configuring a transmission pattern that includes a common silent period across all TRPs, as described above, may generally be effective to ensure that each TRP has an opportunity to initiate a channel occupancy time. However, in some cases, the common silent period may be unnecessary when transmissions by one or more TRPs are unlikely to affect the ability of one or more other TRPs to initiate a channel occupancy time. For example, one or more TRPs may be geographically remote from other TRPs such that transmissions by the geographically remote TRPs are unlikely to be detected. In another example, different TRPs may transmit in different beam directions, whereby the different TRPs may successfully contend for access to the unlicensed channel even if one TRP is transmitting during the idle period (or LBT gap) of the other TRP. Accordingly, as shown in FIG. 7C, and by reference number 730, a joint transmission pattern may be configured in which each TRP blanks the LBT gaps of other TRPs that are within a threshold distance of the TRP and/or transmitting in a beam direction that at least partially overlaps with a beam direction in which the TRP is transmitting. For example, in FIG. 7C, TRP₃ may be located far away from TRP₁ and TRP₂ and/or may be communicating using a beam direction that is different from beam directions in which TRP₁ and TRP₂ are communicating. In this example, as shown, TRP₁ and TRP₂ may transmit during the idle period of TRP₃, and TRP₃ may transmit during the idle periods of TRP₁ and TRP₂.

In each of the various options described above, the multiple TRPs may be communicating with a UE (not shown) in FBE mode. Accordingly, in cases where the UE is permitted to initiate a channel occupancy time, transmissions by the TRPs during the idle period of the UE may block the UE from initiating a channel occupancy time. In some aspects, the one or more idle periods in the joint transmission pattern that is configured across the TRPs may therefore include at least a portion of the idle period of the UE. For example, in addition to blanking the idle period(s) and/or LBT gap(s) of the other TRPs (with the possible exception of TRPs that are not within a threshold distance of the TRP and/or using a different beam direction), each TRP may blank the idle period(s) of the UE(s) connected to the multiple TRPs or the LBT gap(s) of the UE(s) connected to the multiple TRPs. In this way, the UEs that are connected to the multiple TRPs may also have an opportunity to perform an LBT procedure to attempt to initiate a channel occupancy time in a next FFP.

As indicated above, FIGS. 7A-7C are provided as examples. Other examples may differ from what is described with regard to FIGS. 7A-7C.

FIGS. 8A-8C are diagrams illustrating examples 800 associated with UE behavior related to idle period handling for mTRP operation where multiple TRPs have different FFP structures, in accordance with the present disclosure. For example, as described herein, multiple TRPs (e.g., TRPs 335 and/or TRPs 405, shown as TRP₁, TRP₂, and TRP₃) may communicate with a UE (e.g., UE 120 and/or the like) in a wireless network (e.g., wireless network 100) using one or more unlicensed channels in FBE mode. In some aspects, as described herein, the TRPs and the UE may be allowed to initiate a channel occupancy time in FBE mode, and the TRPs may be configured with different FFP structures (e.g., different start times and/or different offsets). Accordingly, as described herein, the UE may determine a transmission pattern that includes one or more idle periods to ensure that there are one or more silent periods during which the UE is not transmitting, such that other devices (e.g., the TRPs or LBE devices) may successfully access the unlicensed channel(s).

For example, in some aspects, the UE may determine a transmission pattern that includes one or more idle periods associated with an initiating node that acquired a current channel occupancy time. For example, if the UE is an initiating node that acquired the current channel occupancy time, the UE may refrain from transmitting during the idle period of the FFP associated with the UE and may transmit during the idle periods of the TRPs. On the other hand, if the UE is a responding node sharing a current channel occupancy time that was acquired by a TRP, the UE may refrain from transmitting during the idle period of the FFP associated with the TRP. In such cases, because the multiple TRPs have different FFP structures, the UE may need to determine which TRP is sharing the current channel occupancy time with the UE, and may need to determine the start time and the duration of the idle period. For example, in some aspects, a serving cell may transmit, to the UE, DCI (e.g., DCI format 20) that carries an indication (e.g., an availableRB-SetPerCellPerTRP-r16 parameter and/or a CO-DurationPerCellPerTRP-r16 parameter) that includes an index or other identifier associated with the TRP that is sharing the current channel occupancy time. Furthermore, in some aspects, the UE may be provided an RRC configuration that indicates the start time and duration of the idle period for each TRP, such that the UE can determine the idle period to blank based on the indication carried in the DCI. Alternatively, in some aspects, the DCI may further carry information that indicates the start time and the duration of the idle period for the TRP sharing the current channel occupancy time. In this way, in cases where the UE is sharing a current channel occupancy time that was initiated by a TRP, the UE may determine the idle period to blank when the UE is connected to multiple TRPs with different FFP structures.

However, in cases where the UE is sharing a channel occupancy time with a first TRP in order to transmit to a second TRP, the UE may transmit during the idle period of the second TRP and/or other TRPs. In such cases, the UE transmissions may block other devices (e.g., the TRPs and/or LBE devices) from accessing the unlicensed channel. Accordingly, as shown in FIG. 8A, and by reference number 810, the UE may be configured to follow a joint transmission pattern in which the UE follows its own idle period as well as the idle period of a TRP sharing a current channel occupancy time with the UE and any TRP(s) to which the UE is transmitting. For example, in FIG. 8A, the UE may be sharing a channel occupancy time initiated by TRP₂ during the second FFP of the UE, and the UE may be transmitting to TRP₁ while being connected to (but not transmitting to) TRP₃. Accordingly, in the first FFP of the UE, the UE may initiate a channel occupancy time to transmit to TRP₁, whereby the UE may refrain from transmitting during the idle period of TRP₁ and during the idle period of the UE in the first FFP. In the second FFP, the UE may be sharing a channel occupancy time acquired by TRP₂, and may therefore refrain from transmitting during the idle period of TRP₂ and during the idle period of the UE in the second FFP (note that the idle period of TRP₁ that is receiving transmissions from the UE does not overlap with the second FFP of the UE). In the third FFP, the UE again refrains from transmitting during the idle period of TRP₁ that is receiving transmissions from the UE and during the idle period of the UE.

Alternatively, as shown in FIG. 8B, and by reference number 820, the UE may follow a joint transmission pattern in which the UE blanks the idle period of each TRP to which the UE is connected. For example, in addition to refraining from transmitting during the idle period of the UE in each FFP, the UE may further refrain from transmitting during portions of any TRP idle periods that are non-overlapping with the idle period of the UE. In this way, the joint transmission pattern shown in FIG. 8B may ensure that the UE is always silent during the TRP idle periods in order to provide the TRPs with an opportunity to contend for access to the unlicensed channel. Alternatively, as shown in FIG. 8C, and by reference number 830, the UE may follow a joint transmission pattern in which the UE follows its own idle period as well as the idle period of a TRP sharing a current channel occupancy time with the UE and the idle period of any TRPs to which the UE is transmitting. For any other TRPs (e.g., TRPs that are neither sharing a current channel occupancy time with the UE nor receiving transmissions from the UE), the UE may blank only the LBT gap(s) of the connected TRP(s). In this way, the UE may provide each TRP with an opportunity to contend for access to the unlicensed channel while also improving spectral efficiency by allowing transmissions during a portion of the idle period of the TRP(s) that are not receiving transmissions from the UE.

As indicated above, FIGS. 8A-8C are provided as examples. Other examples may differ from what is described with regard to FIGS. 8A-8C.

FIGS. 9A-9B are diagrams illustrating examples 900 associated with TRP behavior related to idle period handling for mTRP operation where an idle period of another TRP overlaps with the start of an FFP, in accordance with the present disclosure. For example, as described herein, a first TRP and a second TRP (e.g., TRPs 335 and/or TRPs 405, shown as TRP₁ and TRP₂) may communicate with one or more UEs (e.g., UE 120 and/or the like) in a wireless network (e.g., wireless network 100) using one or more unlicensed channels in FBE mode. In some aspects, as described herein, the TRPs may be configured with different FFP structures (e.g., different start times and/or different offsets). Consequently, in some cases, the idle period of a first TRP may be located near the start of the FFP for a second TRP, which may result in the second TRP blocking the first TRP from accessing the unlicensed channel (e.g., the second TRP may be transmitting during the idle period of the first TRP while the first TRP is attempting an LBT procedure). Accordingly, examples 900 relate to behavior that may be employed by a TRP that is configured with an FFP structure in which a channel occupancy time overlaps with the idle period of another TRP.

For example, as shown in FIG. 9A, and by reference number 910, a TRP associated with an FFP structure in which the start of an FFP overlaps with the idle period of another TRP may ignore the idle period of the other TRP. For example, in FIG. 9A, TRP₁ and TRP₂ are associated with different FFP structures, which have the same period and different offsets in the illustrated example. Accordingly, TRP₁ could potentially initiate a channel occupancy time in each FFP, which may block TRP₂ from successfully contending for access to the unlicensed channel. However, TRP₁ may share the channel occupancy time that is initiated in each FFP with TRP₂, whereby TRP₂ may be permitted to transmit during the channel occupancy time of TRP₁ despite being unable to initiate a channel occupancy time. Accordingly, in some aspects, TRP₁ may ignore the idle period of TRP₂ and channel occupancy time sharing may be used to ensure that TRP₂ is able to transmit on the unlicensed channel. Alternatively, as shown in FIG. 9B, and by reference number 920, the TRP that has the start of an FFP overlapping with the idle period of another TRP may blank the LBT gap of the other TRP if the overlapping idle period exceeds an LBT time. For example, in FIG. 9B, TRP₁ may remain silent during the LBT gap of TRP₂ (e.g., during a period of less than 16 μs) prior to the start of the FFP for TRP₂. Furthermore, in some aspects, a UE that is communicating with one or more TRPs may follow similar rules in cases where the start of an FFP associated with the UE overlaps with the idle period of a TRP.

As indicated above, FIGS. 9A-9B are provided as examples. Other examples may differ from what is described with regard to FIGS. 9A-9B.

FIG. 10 is a diagram illustrating an example process 1000 performed, for example, by a UE, in accordance with the present disclosure. Example process 1000 is an example where the UE (e.g., UE 120) performs operations associated with idle period handling for mTRP operation.

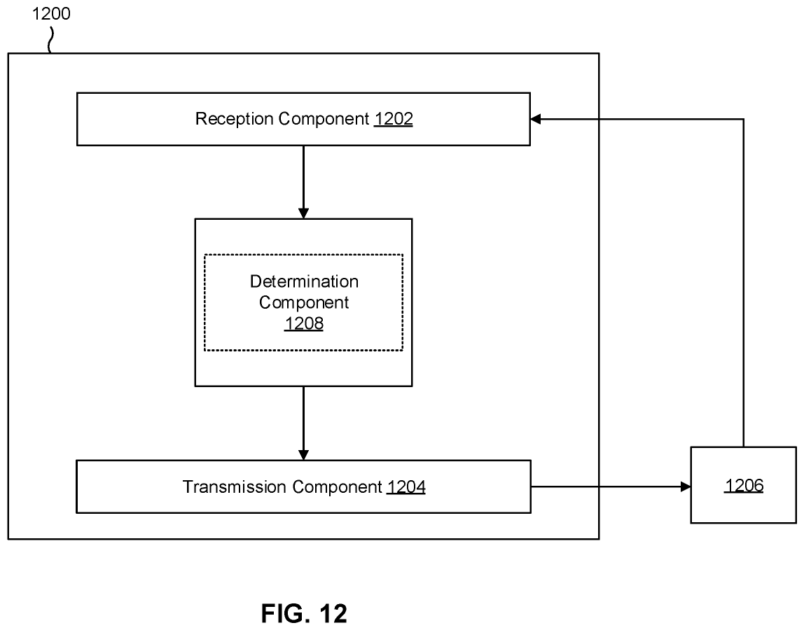

As shown in FIG. 10, in some aspects, process 1000 may include determining, among the UE and multiple TRPs communicating with the UE in an FBE mode, an initiating node that acquired a current channel occupancy time (block 1010). For example, the UE (e.g., using determination component 1208, depicted in FIG. 12) may determine, among the UE and multiple TRPs communicating with the UE in an FBE mode, an initiating node that acquired a current channel occupancy time, as described above.

As further shown in FIG. 10, in some aspects, process 1000 may include determining a transmission pattern that includes one or more idle periods based at least in part on an FFP structure associated with the initiating node that acquired the current channel occupancy time (block 1020). For example, the UE (e.g., using determination component 1208, depicted in FIG. 12) may determine a transmission pattern that includes one or more idle periods based at least in part on an FFP structure associated with the initiating node that acquired the current channel occupancy time, as described above.

As further shown in FIG. 10, in some aspects, process 1000 may include refraining from transmitting during the one or more idle periods, wherein the one or more idle periods include at least an idle period associated with the UE (block 1030). For example, the UE (e.g., using transmission component 1204, depicted in FIG. 12) may refrain from transmitting during the one or more idle periods, wherein the one or more idle periods include at least an idle period associated with the UE, as described above.

Process 1000 may include additional aspects, such as any single aspect or any combination of aspects described below and/or in connection with one or more other processes described elsewhere herein.

In a first aspect, the one or more idle periods include an idle period in the FFP structure associated with the initiating node.

In a second aspect, alone or in combination with the first aspect, the UE is the initiating node or a responding node sharing the current channel occupancy time with the initiating node.

In a third aspect, alone or in combination with one or more of the first and second aspects, the one or more idle periods include a common idle period associated with the multiple TRPs.

In a fourth aspect, alone or in combination with one or more of the first through third aspects, the one or more idle periods include an idle period associated with a TRP, of the multiple TRPs communicating with the UE, that is sharing the current channel occupancy time with the UE.

In a fifth aspect, alone or in combination with one or more of the first through fourth aspects, process 1000 includes determining that FFP structures associated with the multiple TRPs include one or more different durations or different offsets, receiving DCI that carries an indication identifying the TRP that is sharing the current channel occupancy time with the UE, and determining the idle period associated with the TRP that is sharing the current channel occupancy time with the UE based at least in part on the indication in the DCI.

In a sixth aspect, alone or in combination with one or more of the first through fifth aspects, the idle period associated with the TRP is indicated in the DCI that carries the indication or an RRC configuration that indicates respective idle periods for the multiple TRPs.

In a seventh aspect, alone or in combination with one or more of the first through sixth aspects, the one or more idle periods include an idle period associated with one or more of a first TRP, of the multiple TRPs, that is sharing the current channel occupancy time with the UE, or a second TRP, of the multiple TRPs, receiving transmissions from the UE during the current channel occupancy time.

In an eighth aspect, alone or in combination with one or more of the first through seventh aspects, the one or more idle periods cover LBT gaps associated with each of the multiple TRPs communicating with the UE.

In a ninth aspect, alone or in combination with one or more of the first through eighth aspects, the one or more idle periods include respective idle periods associated with each of the multiple TRPs communicating with the UE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a TRP, in accordance with the present disclosure. Example process 1100 is an example where the TRP (e.g., TRP 335 and/or TRP 405) performs operations associated with idle period handling for mTRP.

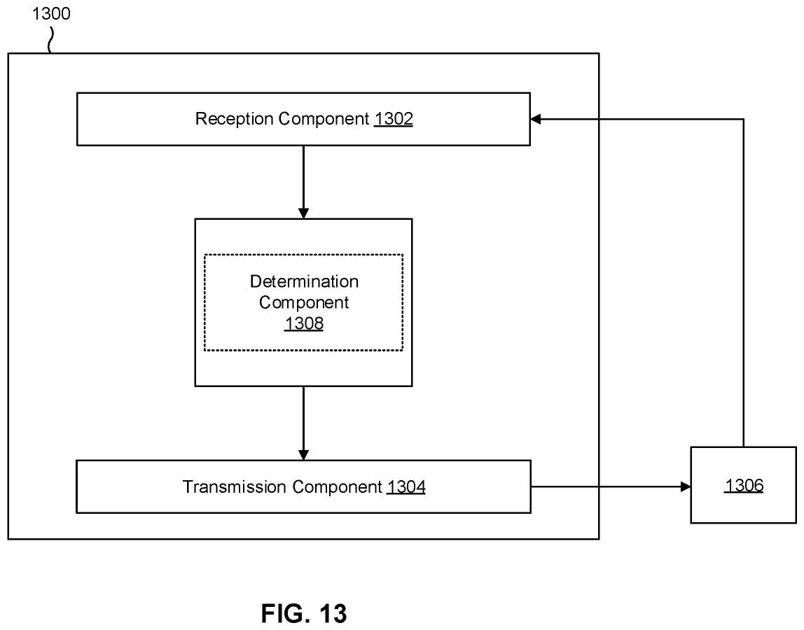

As shown in FIG. 11, in some aspects, process 1100 may include determining, among a UE, the TRP, and one or more other TRPs communicating with the UE in an FBE mode, an initiating node that acquired a current channel occupancy time (block 1110). For example, the TRP (e.g., using determination component 1308, depicted in FIG. 13) may determine, among a UE, the TRP, and one or more other TRPs communicating with the UE in an FBE mode, an initiating node that acquired a current channel occupancy time, as described above.

As further shown in FIG. 11, in some aspects, process 1100 may include determining a transmission pattern that includes one or more idle periods based at least in part on an FFP structure associated with the initiating node that acquired the current channel occupancy time (block 1120). For example, the TRP (e.g., using determination component 1308, depicted in FIG. 13) may determine a transmission pattern that includes one or more idle periods based at least in part on an FFP structure associated with the initiating node that acquired the current channel occupancy time, as described above.

As further shown in FIG. 11, in some aspects, process 1100 may include refraining from transmitting during the one or more idle periods, wherein the one or more idle periods include at least an idle period associated with the TRP (block 1130). For example, the TRP (e.g., using transmission component 1304, depicted in FIG. 13) may refrain from transmitting during the one or more idle periods, wherein the one or more idle periods include at least an idle period associated with the TRP, as described above.

Process 1100 may include additional aspects, such as any single aspect or any combination of aspects described below and/or in connection with one or more other processes described elsewhere herein.

In a first aspect, the one or more idle periods include an idle period in the FFP structure associated with the initiating node.

In a second aspect, alone or in combination with the first aspect, the TRP is the initiating node or a responding node sharing the current channel occupancy time with the initiating node.

In a third aspect, alone or in combination with one or more of the first and second aspects, the one or more idle periods include an idle period associated with the UE.

In a fourth aspect, alone or in combination with one or more of the first through third aspects, the one or more idle periods cover an LBT gap associated with the UE.

In a fifth aspect, alone or in combination with one or more of the first through fourth aspects, the one or more idle periods are determined independent from an idle period associated with the UE.

In a sixth aspect, alone or in combination with one or more of the first through fifth aspects, the one or more idle periods include respective idle periods associated with each of the one or more other TRPs.

In a seventh aspect, alone or in combination with one or more of the first through sixth aspects, the one or more idle periods further include an idle period associated with the UE.

In an eighth aspect, alone or in combination with one or more of the first through seventh aspects, the one or more idle periods cover an LBT gap associated with the UE.

In a ninth aspect, alone or in combination with one or more of the first through eighth aspects, the one or more idle periods cover respective LBT gaps associated with each of the one or more other TRPs.

In a tenth aspect, alone or in combination with one or more of the first through ninth aspects, the one or more idle periods further cover an LBT gap associated with the UE.

In an eleventh aspect, alone or in combination with one or more of the first through tenth aspects, the one or more idle periods cover LBT gaps associated with one or more TRPs, of the one or more other TRPs, that are within a threshold distance of the TRP.

In a twelfth aspect, alone or in combination with one or more of the first through eleventh aspects, the one or more idle periods cover LBT gaps associated with one or more TRPs, of the one or more other TRPs, that are communicating in one or more beam directions that at least partially overlap with one or more beam directions of the TRP.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a block diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include a determination component 1208, among other examples.

In some aspects, the apparatus 1200 may be configured to perform one or more operations described herein in connection with FIG. 6, FIGS. 7A-7C, FIGS. 8A-8C, and/or FIGS. 9A-9B. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described above in connection with FIG. 2. Additionally, or alternatively, one or more components shown in FIG. 12 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1206. In some aspects, the reception component 1202 may include one or more antennas, a demodulator, a MIMO detector, a receive processor, a controller/processor, a memory, or a combination thereof, of the UE described above in connection with FIG. 2.

The transmission component 1204 may transmit communications, such as reference signals, control information, data communications, or a combination thereof, to the apparatus 1206. In some aspects, one or more other components of the apparatus 1206 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modulator, a transmit MIMO processor, a transmit processor, a controller/processor, a memory, or a combination thereof, of the UE described above in connection with FIG. 2. In some aspects, the transmission component 1204 may be co-located with the reception component 1202 in a transceiver.

The determination component 1208 may determine, among the UE and multiple TRPs communicating with the UE in an FBE mode, an initiating node that acquired a current channel occupancy time. The determination component 1208 may determine a transmission pattern that includes one or more idle periods based at least in part on an FFP structure associated with the initiating node that acquired the current channel occupancy time. The transmission component 1204 may refrain from transmitting during the one or more idle periods, wherein the one or more idle periods include at least an idle period associated with the UE.

The determination component 1208 may determine that FFP structures associated with the multiple TRPs include one or more different durations or different offsets. The reception component 1202 may receive DCI that carries an indication identifying the TRP that is sharing the current channel occupancy time with the UE. The determination component 1208 may determine the idle period associated with the TRP that is sharing the current channel occupancy time with the UE based at least in part on the indication in the DCI.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a block diagram of an example apparatus 1300 for wireless communication. The apparatus 1300 may be a TRP, or a TRP may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a determination component 1308, among other examples.

In some aspects, the apparatus 1300 may be configured to perform one or more operations described herein in connection with FIG. 6, FIGS. 7A-7C, FIGS. 8A-8C, and/or FIGS. 9A-9B. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the base station described above in connection with FIG. 2. Additionally, or alternatively, one or more components shown in FIG. 13 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1306. In some aspects, the reception component 1302 may include one or more antennas, a demodulator, a MIMO detector, a receive processor, a controller/processor, a memory, or a combination thereof, of the base station described above in connection with FIG. 2.

The transmission component 1304 may transmit communications, such as reference signals, control information, data communications, or a combination thereof, to the apparatus 1306. In some aspects, one or more other components of the apparatus 1306 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modulator, a transmit MIMO processor, a transmit processor, a controller/processor, a memory, or a combination thereof, of the base station described above in connection with FIG. 2. In some aspects, the transmission component 1304 may be co-located with the reception component 1302 in a transceiver.

The determination component 1308 may determine, among a UE, the TRP, and one or more other TRPs communicating with the UE in an FBE mode, an initiating node that acquired a current channel occupancy time. The determination component 1308 may determine a transmission pattern that includes one or more idle periods based at least in part on an FFP structure associated with the initiating node that acquired the current channel occupancy time. The transmission component 1304 may refrain from transmitting during the one or more idle periods, wherein the one or more idle periods include at least an idle period associated with the TRP.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:
Aspect 1: A method of wireless communication performed by a UE, comprising: determining, among the UE and multiple TRPs communicating with the UE in an FBE mode, an initiating node that acquired a current channel occupancy time; determining a transmission pattern that includes one or more idle periods based at least in part on an FFP structure associated with the initiating node that acquired the current channel occupancy time; and refraining from transmitting during the one or more idle periods, wherein the one or more idle periods include at least an idle period associated with the UE.
Aspect 2: The method of Aspect 1, wherein the one or more idle periods include an idle period in the FFP structure associated with the initiating node.
Aspect 3: The method of any of Aspects 1-2, wherein the UE is the initiating node or a responding node sharing the current channel occupancy time with the initiating node.
Aspect 4: The method of any of Aspects 1-3, wherein the one or more idle periods include a common idle period associated with the multiple TRPs.
Aspect 5: The method of any of Aspects 1-4, wherein the one or more idle periods include an idle period associated with a TRP, of the multiple TRPs communicating with the UE, that is sharing the current channel occupancy time with the UE.
Aspect 6: The method of Aspect 5, further comprising: determining that FFP structures associated with the multiple TRPs include one or more different durations or different offsets; receiving DCI that carries an indication identifying the TRP that is sharing the current channel occupancy time with the UE; and determining the idle period associated with the TRP that is sharing the current channel occupancy time with the UE based at least in part on the indication in the DCI.
Aspect 7: The method of Aspect 6, wherein the idle period associated with the TRP is indicated in the DCI that carries the indication or an RRC configuration that indicates respective idle periods for the multiple TRPs.
Aspect 8: The method of any of Aspects 1-7, wherein the one or more idle periods include an idle period associated with one or more of a first TRP, of the multiple TRPs, that is sharing the current channel occupancy time with the UE, or a second TRP, of the multiple TRPs, receiving transmissions from the UE during the current channel occupancy time.
Aspect 9: The method of Aspect 8, wherein the one or more idle periods cover LBT gaps associated with each of the multiple TRPs communicating with the UE.
Aspect 10: The method of any of Aspects 1-9, wherein the one or more idle periods include respective idle periods associated with each of the multiple TRPs communicating with the UE.
Aspect 11: A method of wireless communication performed by a TRP, comprising: determining, among a UE, the TRP, and one or more other TRPs communicating with the UE in an FBE mode, an initiating node that acquired a current channel occupancy time; determining a transmission pattern that includes one or more idle periods based at least in part on an FFP structure associated with the initiating node that acquired the current channel occupancy time; and refraining from transmitting during the one or more idle periods, wherein the one or more idle periods include at least an idle period associated with the TRP.
Aspect 12: The method of Aspect 11, wherein the one or more idle periods include an idle period in the FFP structure associated with the initiating node.
Aspect 13: The method of any of Aspects 11-12, wherein the TRP is the initiating node or a responding node sharing the current channel occupancy time with the initiating node.
Aspect 14: The method of any of Aspects 11-13, wherein the one or more idle periods include an idle period associated with the UE.
Aspect 15: The method of any of Aspects 11-14, wherein the one or more idle periods cover an LBT gap associated with the UE.
Aspect 16: The method of any of Aspects 11-13, wherein the one or more idle periods are determined independent from an idle period associated with the UE.
Aspect 17: The method of any of Aspects 11-16, wherein the one or more idle periods include respective idle periods associated with each of the one or more other TRPs.
Aspect 18: The method of Aspect 17, wherein the one or more idle periods further include an idle period associated with the UE.
Aspect 19: The method of any of Aspects 17-18, wherein the one or more idle periods cover an LBT gap associated with the UE.
Aspect 20: The method of any of Aspects 11-19, wherein the one or more idle periods cover respective LBT gaps associated with each of the one or more other TRPs.
Aspect 21: The method of Aspect 20, wherein the one or more idle periods further cover an LBT gap associated with the UE.
Aspect 22: The method of any of Aspects 11-21, wherein the one or more idle periods cover LBT gaps associated with one or more TRPs, of the one or more other TRPs, that are within a threshold distance of the TRP.
Aspect 23: The method of any of Aspects 11-22, wherein the one or more idle periods cover LBT gaps associated with one or more TRPs, of the one or more other TRPs, that are communicating in one or more beam directions that at least partially overlap with one or more beam directions of the TRP.
Aspect 24: An apparatus for wireless communication at a device, comprising a processor; memory coupled with the processor; and instructions stored in the memory and executable by the processor to cause the apparatus to perform the method of any of Aspects 1-10.
Aspect 25: A device for wireless communication, comprising a memory and one or more processors coupled to the memory, the memory and the one or more processors configured to perform the method of any of Aspects 1-10.
Aspect 26: An apparatus for wireless communication, comprising at least one means for performing the method of any of Aspects 1-10.
Aspect 27: A non-transitory computer-readable medium storing code for wireless communication, the code comprising instructions executable by a processor to perform the method of any of Aspects 1-10.
Aspect 28: A non-transitory computer-readable medium storing a set of instructions for wireless communication, the set of instructions comprising one or more instructions that, when executed by one or more processors of a device, cause the device to perform the method of any of Aspects 1-10.
Aspect 29: An apparatus for wireless communication at a device, comprising a processor; memory coupled with the processor; and instructions stored in the memory and executable by the processor to cause the apparatus to perform the method of any of Aspects 11-23.
Aspect 30: A device for wireless communication, comprising a memory and one or more processors coupled to the memory, the memory and the one or more processors configured to perform the method of any of Aspects 11-23.
Aspect 31: An apparatus for wireless communication, comprising at least one means for performing the method of any of Aspects 11-23.
Aspect 32: A non-transitory computer-readable medium storing code for wireless communication, the code comprising instructions executable by a processor to perform the method of any of Aspects 11-23.
Aspect 33: A non-transitory computer-readable medium storing a set of instructions for wireless communication, the set of instructions comprising one or more instructions that, when executed by one or more processors of a device, cause the device to perform the method of any of Aspects 11-23.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
determining, among the UE and multiple transmit receive points (TRPs) communicating with the UE in a frame based equipment (FBE) mode, an initiating node that acquired a current channel occupancy time;
determining a transmission pattern that includes one or more idle periods based at least in part on a fixed frame period (FFP) structure associated with the initiating node that acquired the current channel occupancy time; and
refraining from transmitting during the one or more idle periods, wherein the one or more idle periods include at least an idle period associated with the UE.

2. The method of claim 1, wherein the one or more idle periods include an idle period in the FFP structure associated with the initiating node.

3. The method of claim 2, wherein the UE is the initiating node or a responding node sharing the current channel occupancy time with the initiating node.

4. The method of claim 1, wherein the one or more idle periods include a common idle period associated with the multiple TRPs.

5. The method of claim 1, wherein the one or more idle periods include an idle period associated with a TRP, of the multiple TRPs communicating with the UE, that is sharing the current channel occupancy time with the UE.

6. The method of claim 5, further comprising:
determining that FFP structures associated with the multiple TRPs include one or more different durations or different offsets;
receiving downlink control information (DCI) that carries an indication identifying the TRP that is sharing the current channel occupancy time with the UE; and
determining the idle period associated with the TRP that is sharing the current channel occupancy time with the UE based at least in part on the indication in the DCI.

7. The method of claim 6, wherein the idle period associated with the TRP is indicated in the DCI that carries the indication or a radio resource control configuration that indicates respective idle periods for the multiple TRPs.

8. The method of claim 1, wherein the one or more idle periods include an idle period associated with one or more of a first TRP, of the multiple TRPs, that is sharing the current channel occupancy time with the UE, or a second TRP, of the multiple TRPs, receiving transmissions from the UE during the current channel occupancy time.

9. The method of claim 8, wherein the one or more idle periods cover listen-before-talk gaps associated with each of the multiple TRPs communicating with the UE.

10. The method of claim 1, wherein the one or more idle periods include respective idle periods associated with each of the multiple TRPs communicating with the UE.

11. A method of wireless communication performed by a transmit receive point (TRP), comprising:
determining, among a user equipment (UE), the TRP, and one or more other TRPs communicating with the UE in a frame based equipment (FBE) mode, an initiating node that acquired a current channel occupancy time;
determining a transmission pattern that includes one or more idle periods based at least in part on a fixed frame period (FFP) structure associated with the initiating node that acquired the current channel occupancy time; and
refraining from transmitting during the one or more idle periods, wherein the one or more idle periods include at least an idle period associated with the TRP.

12. The method of claim 11, wherein the one or more idle periods include an idle period in the FFP structure associated with the initiating node.

13. The method of claim 12, wherein the TRP is the initiating node or a responding node sharing the current channel occupancy time with the initiating node.

14. The method of claim 11, wherein the one or more idle periods include an idle period associated with the UE.

15. The method of claim 11, wherein the one or more idle periods cover a listen-before-talk gap associated with the UE.

16. The method of claim 11, wherein the one or more idle periods are determined independent from an idle period associated with the UE.

17. The method of claim 11, wherein the one or more idle periods include respective idle periods associated with each of the one or more other TRPs.

18. The method of claim 17, wherein the one or more idle periods further include an idle period associated with the UE.

19. The method of claim 17, wherein the one or more idle periods cover a listen-before-talk gap associated with the UE.

20. The method of claim 11, wherein the one or more idle periods cover respective listen-before-talk (LBT) gaps associated with each of the one or more other TRPs.

21. The method of claim 20, wherein the one or more idle periods further cover an LBT gap associated with the UE.

22. The method of claim 11, wherein the one or more idle periods cover listen-before-talk gaps associated with one or more TRPs, of the one or more other TRPs, that are within a threshold distance of the TRP.

23. The method of claim 11, wherein the one or more idle periods cover listen-before-talk gaps associated with one or more TRPs, of the one or more other TRPs, that are communicating in one or more beam directions that at least partially overlap with one or more beam directions of the TRP.

24. A user equipment (UE) for wireless communication, comprising:
a memory; and
one or more processors, coupled to the memory, configured to:
determine, among the UE and multiple transmit receive points (TRPs) communicating with the UE in a frame based equipment (FBE) mode, an initiating node that acquired a current channel occupancy time;
determine a transmission pattern that includes one or more idle periods based at least in part on a fixed frame period (FFP) structure associated with the initiating node that acquired the current channel occupancy time; and
refrain from transmitting during the one or more idle periods, wherein the one or more idle periods include at least an idle period associated with the UE.

25. The UE of claim 24, wherein the one or more idle periods include a common idle period associated with the multiple TRPs.

26. The UE of claim 24, wherein the one or more idle periods include an idle period associated with one or more of a first TRP, of the multiple TRPs, that is sharing the current channel occupancy time with the UE, or a second TRP, of the multiple TRPs, receiving transmissions from the UE during the current channel occupancy time.

27. The UE of claim 24, wherein the one or more idle periods include respective idle periods associated with each of the multiple TRPs communicating with the UE.

28. A transmit receive point (TRP) for wireless communication, comprising:
a memory; and
one or more processors, coupled to the memory, configured to:
determine, among a user equipment (UE), the TRP, and one or more other TRPs communicating with the UE in a frame based equipment (FBE) mode, an initiating node that acquired a current channel occupancy time;
determine a transmission pattern that includes one or more idle periods based at least in part on a fixed frame period (FFP) structure associated with the initiating node that acquired the current channel occupancy time; and
refrain from transmitting during the one or more idle periods, wherein the one or more idle periods include at least an idle period associated with the TRP.

29. The TRP of claim 28, wherein the one or more idle periods cover a listen-before-talk gap associated with the UE.

30. The TRP of claim 28, wherein the one or more idle periods cover respective listen-before-talk (LBT) gaps associated with each of the one or more other TRPs communicating with the UE.
